(19) United States
(12) Patent Application Publication
(10) Pub. No.: US 2016/0112895 A1
(43) Pub. Date: Apr. 21, 2016

(54) BASE STATION DEVICE, MOBILE STATION DEVICE, SERVICE QUALITY CONTROL DEVICE, AND COMMUNICATION METHODS

(71) Applicant: FUJITSU LIMITED, Kawasaki-shi (JP)

(72) Inventors: Takayoshi ODE, Yokohama (JP); Yoshiko KOIZUMI, Kawasaki (JP)

(73) Assignee: FUJITSU LIMITED, Kawasaki-shi (JP)

(21) Appl. No.: 14/976,594

(22) Filed: Dec. 21, 2015

Related U.S. Application Data
(63) Continuation of application No. PCT/JP2013/067920, filed on Jun. 28, 2013.

(51) Int. Cl. H04W 28/02; H04L 12/851; H04L 12/801

(52) U.S. Cl. CPC H04W 28/0268; H04L 47/14; H04L 47/2425

(57) ABSTRACT

A base station device comprises a detection unit which obtains the results of detection of the packet lengths of packets which are transmitted by data communications of a mobile station device and a service-quality request control unit which controls a request for service quality for data communication corresponding to the results of detection.

### CROSS-REFERENCE TO RELATED APPLICATION

This application is a continuation application based on International Application PCT/JP 2013/067920, filed on Jun. 28, 2013, the contents being incorporated herein by reference.

### FIELD

The embodiments discussed herein relate to a base station device, mobile station device, service-quality control device, and communication methods.

### BACKGROUND

In a mobile communication system, a mobile station device and external network are concatenated by a wireless access network and a cable network. One example of a wireless access network is the LTE (Long Term Evolution) E-UTRAN (Evolved Universal Terrestrial Radio Access Network) standardized by the 3GPP (3rd Generation Partnership Project). The E-UTRAN and external network are concatenated by a network called an EPC (Evolved Packet Core).

As related art, a system and method for determining a learning base for semi-persistent scheduling of data packet flow wireless communication are known. The packetized data flow which is provided to a wireless terminal is completely scheduled in the initial time period so as to collect statistics relating to the scheduled package size (Ss) and inter-packet time (Ts). The cumulative distribution of {S, T} pairs is analyzed to indicate whether the characteristic packet size (SO) and size dispersion (DO) are related to the cumulative distribution. A time interval relating to a characteristic size and dispersion completes a transport format. If the characteristic transport format is extracted, that is, learned, from the accumulated statistics, the semi-persistent scheduling is utilized for a packetized flow. The extracted transport format can be used for optimizing the scheduling efficiency at the time of handover (for example, see PLT 1).

### RELATED ART

### Patent Literature

### PLT 1: Japanese Laid-Open Patent Publication No. 2010-527208

In recent years, the traffic of mobile station devices has been increasing. Due to this, reduction of the congestion which occurs in a network for transmitting communication data of mobile station devices, has become an issue. For example, congestion of a network occurs due to an increase in the processing for transmission and reception of packets etc. at a base station device or devices which form the IP service network. It sometimes occurs due to the control signals which the mobile station devices send and receive. For example, as the wireless control signals for the operating systems (OS) and applications which the mobile station devices run and for wireless communications, control signals of relatively short packet lengths are transmitted. Sometimes the network becomes congested due to the frequent transmission of such control signals. Furthermore, sometimes congestion causes the required transmission speeds to no longer be able to be met or the transmission speeds to drop.

### SUMMARY

According to one aspect of an apparatus, a base station device is provided. The base station device comprises a detection unit which obtains results of detection of packet lengths of packets which are transmitted by data communication of a mobile station device and a service-quality request control unit which controls a request for service quality for data communication according to the results of detection.

According to another aspect of an apparatus, a mobile station device is provided. The mobile station device is comprised of a detection unit which detects packet lengths of packets transmitted by data communication of the mobile station device and a service-quality request control unit which controls a request for service quality for data communication according to the results of detection of the detection unit.

According to another aspect of an apparatus, a service-quality control device is provided. The service-quality control device is comprised of a judgment unit which judges if an application program, by which a mobile station device is performing processing for data communication, is generating packets which have packet lengths of a threshold value or less and a service-quality request designation unit which designates a request for service quality, which differs in accordance with the results of judgment of the judgment unit, as a request for service quality for data communication by the application program.

The object and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIG. 1 is an explanatory view of an example of the configuration of a communication system.

FIG. 2 is an explanatory view of a first example of the functional configuration of a policy control device.

FIG. 3 is an explanatory view of one example of service classes which are designated by a policy designation unit.

FIG. 4 is an explanatory view of a first example of the functional configuration of a base station device.

FIG. 5 is an explanatory view of a first example of the functional configuration of a PDCP (Packet Data Control Protocol) processing unit of a base station device.

FIG. 6 is an explanatory view of a first example of the functional configuration of an RLC (Radio Link Control) processing unit of a base station device.

FIG. 7 is an explanatory view of a first example of the functional configuration of an MAC (Medium Access Control) processing unit of a base station device.

FIG. 8 is an explanatory view of a first example of the functional configuration of a mobile station device.

FIG. 9 is an explanatory view of a first example of the functional configuration of an MAC processing unit of a mobile station device.

FIG. 10 is an explanatory view of a first example of the functional configuration of an RLC processing unit of a mobile station device.

FIG. 11 is an explanatory view of a first example of the functional configuration of a PDCP processing unit of a mobile station device.

FIG. 12 is a sequence diagram for explaining a first example of operation of a communication system.

FIG. 13 is an explanatory view of a second example of the functional configuration of a base station device.

FIG. 14 is an explanatory view of a second example of the functional configuration of a PDCP processing unit of a base station device.

FIG. 15 is an explanatory view of a first example of a detection operation of small packets.

FIG. 16 is an explanatory view of a second example of a detection operation of small packets.

FIG. 17 is an explanatory view of a second example of the functional configuration of an RLC processing unit of a base station device.

FIG. 18 is an explanatory view of a second example of the functional configuration of an MAC processing unit of a base station device.

FIG. 19 is an explanatory view of a second example of the functional configuration of a policy control device.

FIG. 20 is a sequence diagram for explaining a second example of operation of a communication system.

FIG. 21 is an explanatory view of a second example of the functional configuration of a mobile station device.

FIG. 22 is an explanatory view of a second example of the functional configuration of an MAC processing unit of a mobile station device.

FIG. 23 is an explanatory view of a second example of the functional configuration of an RLC processing unit of a mobile station device.

FIG. 24 is an explanatory view of a second example of the functional configuration of a PDCP processing unit of a mobile station device.

FIG. 25 is a sequence diagram for explaining a third example of operation of a communication system.

FIG. 26 is an explanatory view of a third example of the functional configuration of an MAC processing unit of a mobile station device.

FIG. 27 is an explanatory view of a third example of the functional configuration of an RLC processing unit of a mobile station device.

FIG. 28 is an explanatory view of a third example of the functional configuration of a PDCP processing unit of a mobile station device.

FIG. 29 is a sequence diagram for explaining a fourth example of operation of a communication system.

FIG. 30 is a view of the hardware configuration of one example of a base station device.

FIG. 31 is a view of the hardware configuration of one example of a mobile station device.

FIG. 32 is a view of the hardware configuration of one example of a policy control device.

### DESCRIPTION OF EMBODIMENTS

According to the devices or methods which are disclosed herein, the congestion which occurs in a network for transmitting communication data of mobile station devices is lightened. Further, due to lightening of the congestion, the transmission speeds are improved. Further, the required transmission speeds are achieved. Further, the processing loads of the base station device and the devices which form the network are lightened.

### 1. First Embodiment

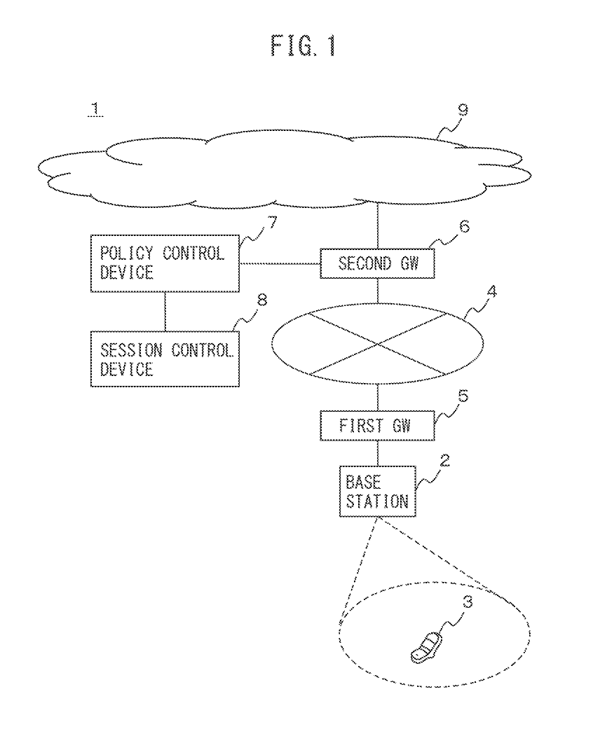

Below, a preferred embodiment will be explained with reference to the attached drawings. FIG. 1 is an explanatory view of an example of the configuration of a communication system. The communication system 1 is comprised of a base station device 2, mobile station device 3, first network 4, first gateway device 5, second gateway device 6, policy control device 7, and session control device 8. In the following explanation and the attached drawings, the gateway device will sometimes be indicated as “GW”. The base station device and mobile station device will respectively sometimes be indicated as the “base station” and the “mobile station”.

The base station 2 forms a wireless communication region (for example, cell or sector) which enables wireless communication with a mobile station 3 and communicates with the mobile station 3 in the wireless communication region in accordance with a predetermined wireless communication standard. The base station 2 is a component element of a wireless access network. Examples of the wireless communication standard are the 3G (3rd Generation) wireless communication standard or LTE etc. which were established by the 3GPP.

The first GW 5 concatenates the wireless access network to a first network 4, while the second GW 6 concatenates the first network 4 and the second network 9. The first GW 5 and second GW 6 transmit user data which is transmitted between the second network 9 and a mobile station 3 through the first network 4.

The first network 4, for example, may be a private network of a telecommunications carrier which provides mobile communication services. The second network 9, for example, may be the Internet or a corporate intranet or other IP (Internet Protocol) service network.

The wireless access network and first network 4 form an IP-CAN (IP Connectivity Access Network) which concatenates the mobile station 3 to the second network 9. To connect the mobile station 3 to the second network 9, a logic channel which transfers user IP packets between the mobile station 3 and second GW 6, called a “bearer”, is formed. The bearer is for example a UMTS (Universal Mobile Telecommunications System) bearer which is defined in the 3G wireless communication standard or an EPS (Evolved Packet System) bearer which is determined by the LTE.

In the following explanation, the example where the communication system 1 is a system based on the LTE will be used. However, this example is not intended so that the communication system which is described herein be applied solely to a communication system based on the LTE. The communication system which is described herein can be broadly applied to systems which control the service quality to be applied to a bearer for carrying user IP packets of a mobile station in accordance with a predefined policy.

The policy control device 7 acquires service information relating to the bearer of the mobile station 3 from the session control device 8. The service information includes identification information of an application program which sends and receives user IP packets using the bearer of the mobile station 3. In the following explanation, the application program which sends and receives user IP packets using the bearer of the mobile station 3 will be simply referred to as the “application program of the mobile station 3”.

The policy control device 7 determines the service class to be applied to the bearer of the mobile station 3 in accordance with the application program of the mobile station 3. The policy control device 7 notifies the determined service class to the first GW 5 and second GW 6. The first GW 5 operates as a policy execution device and controls the transmission speed and transmission delay of the bearer of the mobile station 3 in accordance with the service class which is notified from the policy control device 7.

The second GW 6 operates as a policy execution device and controls the transmission speed and transmission delay of the bearer of the mobile station 3 in accordance with the service class which is notified from the policy control device 7. The second GW 6 notifies the service class to the base station 2.

The policy control device 7 may also for example be a PCRF (Policy and Charging Rules Function) which is defined by the 3GPP. The session control device 8 may also for example be an AF (Application Function). The first GW 5 may also operate, for example, as a BBERF (Bearer Binding and Event Reporting Function). The second GW 6 may also operate as a PCEF (Policy and Charging Enforcement Function). The service class which is notified from the policy control device 7 may also be, for example, a QCI (QoS Class Identifier), QoS (Quality of Service), and QoS class.

The base station 2 controls the transmission speed and transmission delay of user data between the mobile station 3 and the base station 2 in accordance with the service class which is notified from the second GW 6. For example, the base station 2 performs scheduling which selects the wireless resources and MCS (Modulation and Coding Scheme) which are used for transmission of user data between the mobile station 3 and the base station 2. The base station 2 selects the wireless resources and MCS which are used for the bearer of the mobile station 3 so as to satisfy the request for service quality designated by the service class and notified from the second GW 6. The request for service quality may also, for example, be the transmission delay, a condition of the transmission delay, a maximum transmission speed (Maximum Bit Rate), and a guaranteed transmission speed (Guaranteed Bit Rate). The base station 2 notifies the service class which is notified from the second GW 6 to the mobile station 3.

The mobile station 3 controls the transmission speed and transmission delay of user data of the uplink from the mobile station 3 to the base station 2 in accordance with the service class which is notified from the base station 2. For example, the mobile station 3 may request an uplink transmission by satisfying a request for the service quality designated by the service class and notifying the amount of uplink user data of the mobile station. Further, the wireless resources and MCS which are used for transmission may also be requested to the base station 2. For example, the mobile station 3 may decide the resources to be assigned to the bearer from among the uplink wireless resources which are assigned from the base station 2, so as to satisfy the transmission delay and conditions of transmission delay which are designated by the service class.

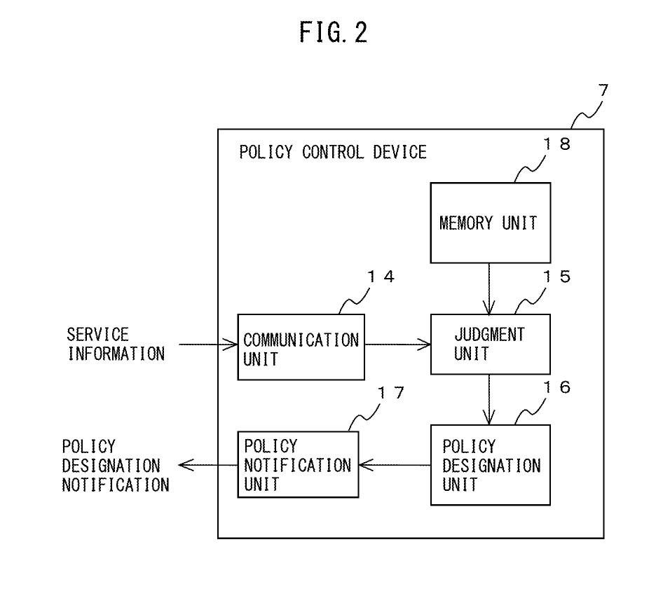

FIG. 2 is an explanatory view of a first example of the functional configuration of the policy control device 7. The policy control device 7 comprises a communication unit 14, judgment unit 15, policy designation unit 16, and policy notification unit 17.

The communication unit 14 receives service information relating to the bearer of the mobile station 3 from the session control device 8. The judgment unit 15 uses the identification information of the application program included in the service information, as the basis, to judge if the application program of the mobile station 3 is causing the generation of packets which have packet lengths shorter than a predetermined threshold value. In the following explanation and attached drawings, packets which have packet lengths shorter than a predetermined threshold value will be referred to as “small packets”.

The judgment unit 15 may, for example, judge if an application program will cause the generation of small packets in advance in accordance with the class, attribute, or name of the application program. The policy control device 7 may be provided with a memory unit 18 in which information of the classes, attributes, or names of application programs, which programs cause the generation of small packets, are stored. The judgment unit 15 may judge if an application program of the mobile station 3 will cause the generation of small packets in accordance with the information of the classes, attributes, or names which are stored in the memory unit 18.

In the same way as the later explained second embodiment or third embodiment, the base station 2 and mobile station 3 may also detect the generation of small packets. The policy control device 7 may receive information for identifying the class, attribute, or name of the application program, which causes the generation of small packets, from the base station 2 and mobile station 3. The policy control device 7 may store, in the memory unit 18, the information for identifying the class, attribute, or name of the application program which is identified based on information received from the base station 2 and mobile station 3.

The policy designation unit 16 uses the service information received from the session control device 8, as the basis, to designate the service class which is to be applied to the bearer of the mobile station 3. If the application program of the mobile station 3 is an application program which causes the generation of small packets, the policy designation unit 16 designates the service class for transmission of small packets as the service class to be applied to the bearer of the mobile station 3. When the application program of the mobile station 3 is not an application program which causes the generation of small packets, the policy designation unit 16 designates a class other than the service class for transmission of small packets as the service class to be applied to the bearer of the mobile station 3.

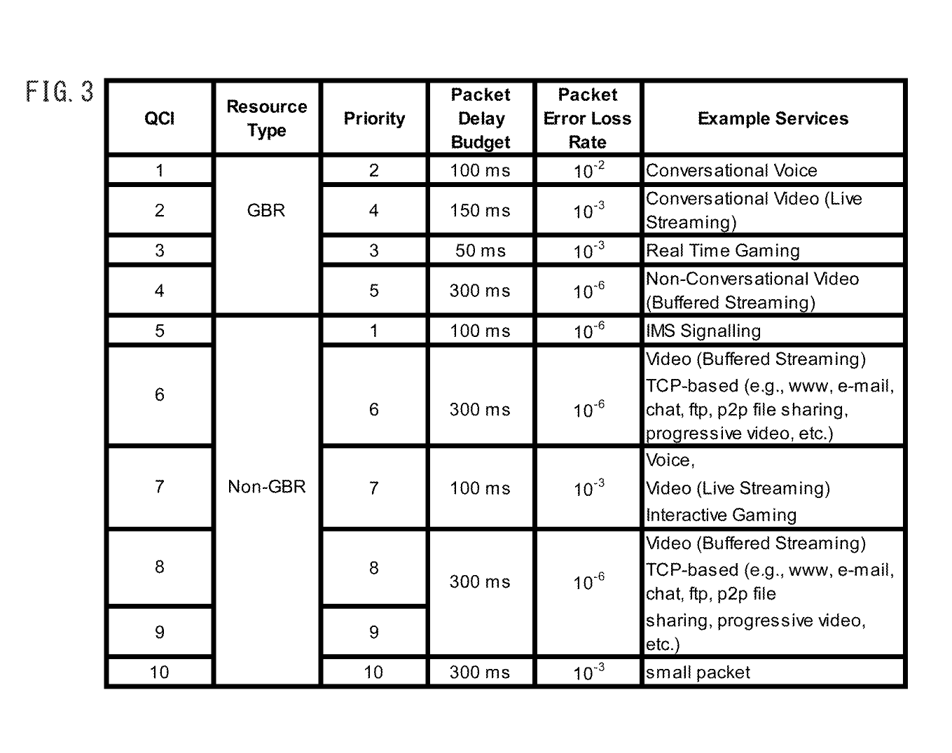

FIG. 3 is an explanatory view of one example of the service classes which is designated by a policy designation unit 16. The service classes QCI=1 to 9 are similar to the service classes which are defined in 3GPP TS23.203 V10.8.0. The service class of QCI=10 is the service class for transmission of small packets.

The type of the data transmission of the service class for transmission of small packets (Resource Type) is a non-bandwidth or non-transmission speed guarantee type (Non-GBR: Guaranteed Bite Rate) not of the bandwidth guarantee type or transmission speed guarantee type (GBR). The priority of the service class for transmission of small packets is “10” and lower than the other service classes. The allowable transmission delay (Packet Delay Budget) and allowable error rate (Packet Error Loss Rate) of the service class for transmission of small packets are respectively “300 msec” and “10⁻³”.

The request for service quality of the service class for transmission of small packets may be eased compared with other service classes so as to prevent congestion which is due to transmission of small packets. For example, the priority of the service class for transmission of small packets of the example of FIG. 3 is lower than the priority of other classes. For example, the requests relating to any of the required transmission speed, allowable transmission delay, quality of transmission, and allowable error rate of the request for service quality of the service class for transmission of small packets may be eased compared with the requests of other service classes.

Refer to FIG. 2. The policy notification unit 17 notifies the service class, which is designated by the policy designation unit 16, to the first GW 5 and second GW 6.

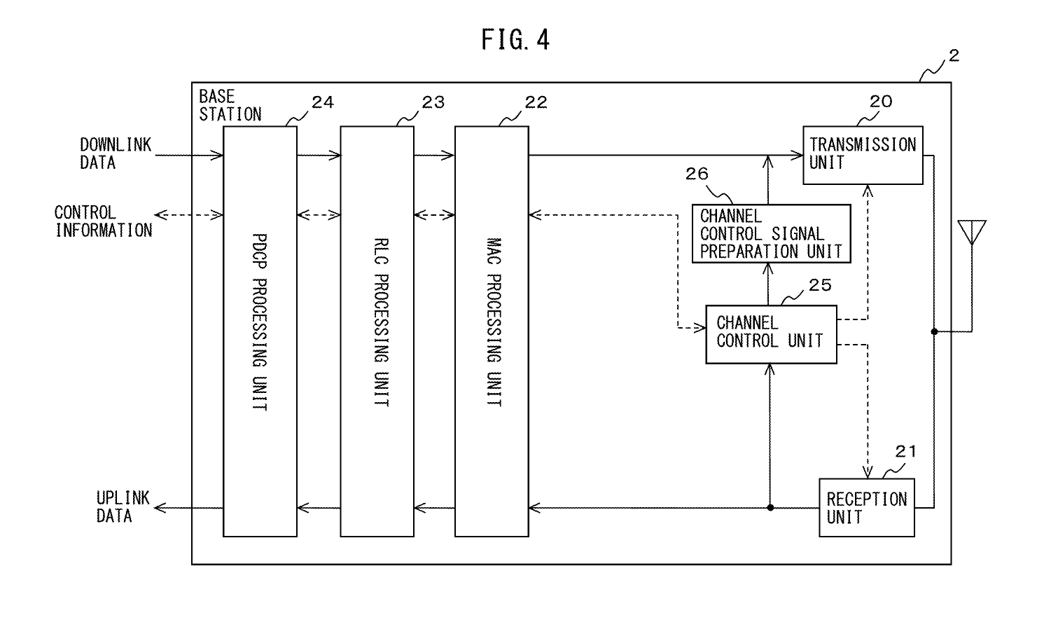

FIG. 4 is an explanatory view of a first example of the functional configuration of the base station 2. The base station 2 comprises a transmission unit 20, reception unit 21, MAC processing unit 22, RLC processing unit 23, and PDCP processing unit 24. The base station 2 also comprises a channel control unit 25 and channel control signal preparation unit 26.

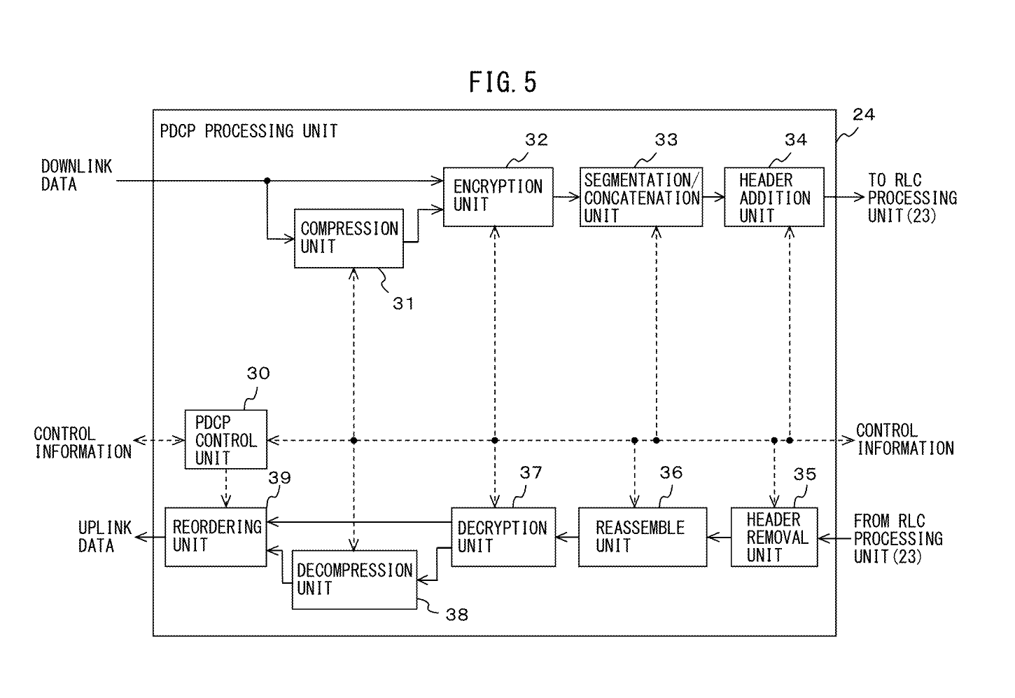

In FIG. 4, the solid line connections indicate the flow of data, while the broken line connections indicate the flow of control signals. The same is true for FIGS. 5 to 11, FIG. 13, FIG. 14, FIG. 17, FIG. 18, FIGS. 21 to 24, and FIG. 26 to FIG. 28.

The transmission unit 20 encodes and modulates the downlink signal which is transmitted to the mobile station 3 and maps the modulated signal on different channels. The transmission unit 20 converts the signal of each channel to an analog signal and converts the converted analog signal to a wireless frequency signal. The transmission unit 20 amplifies the wireless frequency signal and transmits the amplified signal to the mobile station 3 through the antenna.

The reception unit 21 receives the uplink signal which is transmitted from the mobile station 3 through the antenna. The reception unit 21 amplifies the received signal and converts the amplified reception signal to an analog baseband signal. The reception unit 21 performs processing for converting the analog baseband signal to a digital baseband signal, demodulation processing, and decoding processing.

The MAC processing unit 22 performs processing of the MAC layer of the downlink signal transmitted to the mobile station 3 and the uplink signal received from the mobile station 3. Further, the RLC processing unit 23 performs processing of the RLC layer of the downlink signal transmitted to the mobile station 3 and the uplink signal received from the mobile station 3. The PDCP processing unit 24 performs the processing of the PDCP layer of the downlink signal transmitted to the mobile station 3 and the uplink signal received from the mobile station 3.

The channel control unit 25 performs scheduling for selecting the wireless resources and MCS which are used for transmission of user data between the mobile station 3 and the base station 2. The channel control unit 25 receives the service class which is notified from the second GW 6. The channel control unit 25 controls the transmission speed and transmission delay of the user data between the mobile station 3 and the base station 2 in accordance with the service class which is notified from the second GW 6. For example, the channel control unit 25 selects the wireless resources and MCS which are used for the bearer of the mobile station 3 so as to satisfy the transmission delay and the condition of the transmission delay designated by the service class, in accordance with the service class notified from the second GW 6.

The channel control signal preparation unit 26 prepares the channel control signal for designating the wireless resources and MCS which are selected by the line control unit 25 and outputs the channel control signal to the transmission unit 20. The transmission unit 20 transmits the channel control signal to the mobile station 3. Further, the channel control signal preparation unit 26 prepares the service class designation signal for indicating the service class notified from the second GW 6 and outputs the service class designation signal to the transmission unit 20. The transmission unit 20 transmits the service class designation signal to the mobile station 3.

The channel control unit 25 may also receive a request signal of wireless resources to be used for transmission of uplink user data (for example a scheduling request, random access preamble, etc.) from the mobile station 3 and the base station 2. The request signal of wireless resources may also, for example, include information for designating the service class which is notified from the second GW 6. The channel control unit 25 may also select the wireless resources and MCS which are used for transmission of the user data of the uplink, so as to satisfy the request of the service quality of the service class designated by the request of wireless resources.

In the same way as the later mentioned second embodiment, the base station 2 may also detect the generation of small packets. If the generation of small packets is detected, the channel control unit 25 may transmit information for identifying the class, attribute, or name of the application program, which causes the generation of the small packets, to the policy control device 7.

The channel control unit 25 controls the wireless resources and MCS which are used for transmission of user data which the transmission unit 20 and the reception unit 21 send and receive, in accordance with the selected wireless resources and MCS.

FIG. 5 is an explanatory view of a first example of the functional configuration of a PDCP processing unit 24. The PDCP processing unit 24 comprises a PDCP control unit 30, compression unit 31, encryption unit 32, segmentation/concatenation unit 33, and header addition unit 34. The PDCP processing unit 24 comprises a header removal unit 35, reassemble unit 36, decryption unit 37, decompression unit 38, and reordering unit 39.

The PDCP control unit 30 controls the processing of the PDCP layer by the PDCP processing unit 24. The compression unit 31 compresses the header of the packets of the downlink data received from the first GW 5. The encryption unit 32 encrypts the packets of the downlink data. The segmentation/concatenation unit 33 segments or concatenates the packets to, thereby, generate packets of a predetermined length L0. The header addition unit 34 adds headers, which contain control signals or sequence numbers, to packets which the segmentation/concatenation unit 33 generates, so as to generate PDCP PDUs (Packet Data units). The header addition unit 34 outputs the PDCP PDUs to the RLC processing unit 23. Note that the sequence numbers of the headers may be omitted.

The header removal unit 35 receives the RLC SDU (Service Data Units) of the uplink data, which is output from the RLC processing unit 23, as PDCP PDUs. The header removal unit 35 removes the headers from the PDCP PDUs. The reassemble unit 36 couples packets, from which the headers have been removed, to assemble the encrypted packets. The decryption unit 37 decrypts the encrypted packets and converts them to plain text packets. The decompression unit 38 returns the compressed headers, which are contained in the plain text packets, to the original headers. The reordering unit 39 rearranges the order of the plain text packets and outputs the result, as PDCU SDUs, to the first GW 5.

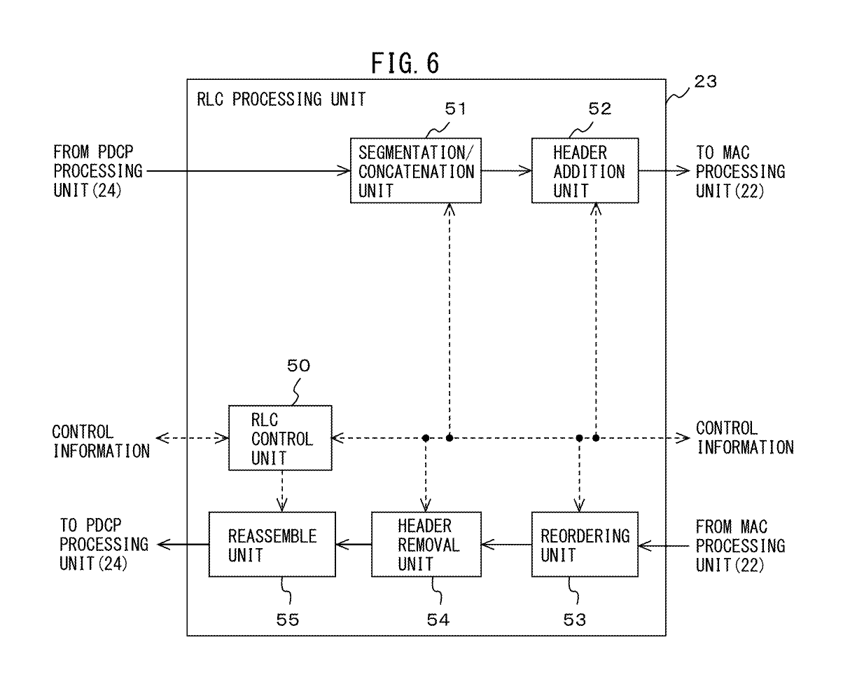

FIG. 6 is an explanatory view of a first example of the functional configuration of a RLC processing unit 23. The RLC processing unit 23 comprises an RLC control unit 50, segmentation/concatenation unit 51, header addition unit 52, reordering unit 53, header removal unit 54, and reassemble unit 55.

The RLC control unit 50 controls the processing of the RLC layer by the RLC processing unit 23. The segmentation/concatenation unit 51 receives the PDCP PDUs which are output from the PDCP processing unit 24, as the RLC SDUs. The segmentation/concatenation unit 51 segments or concatenates the received RLC SDUs to generate packets of a predetermined length L1. The header addition unit 52 adds headers, which contain control signals or sequence numbers, to the packets which the segmentation/concatenation unit 51 generates, so as to generate RLC PDUs. The header addition unit 52 outputs the RLC PDUs to the MAC processing unit 22. Note that, sequence numbers of the headers may be omitted.

The reordering unit 53 receives the MAC SDUs of the uplink data output from the MAC processing unit 22, as the RLC PDUs. The reordering unit 53 rearranges the order of the RLC PDUs and inputs them to the header removal unit 54. The header removal unit 54 removes the headers from the RLC PDUs. The reassemble unit 55 couples the packets, from which the headers have been removed, and assembles PDCP PDUs. The reassemble unit 55 outputs the PDCP PDUs to the PDCP processing unit 24.

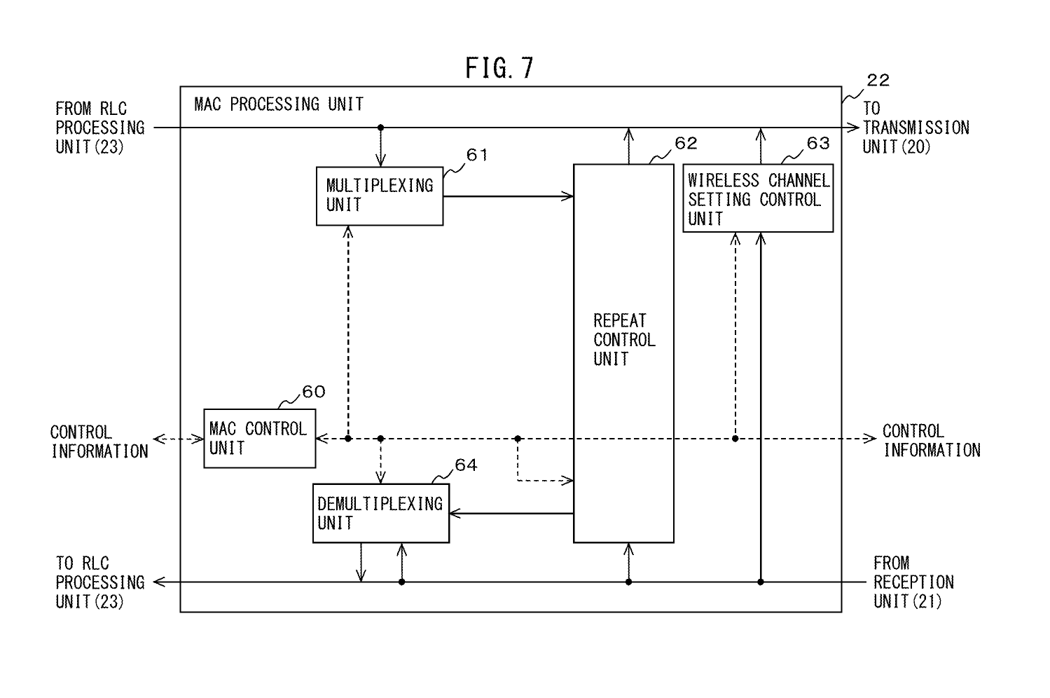

FIG. 7 is an explanatory view of a first example of the functional configuration of the MAC processing unit 22. The MAC processing unit 22 comprises a MAC control unit 60, multiplexer unit 61, retransmission control unit 62, wireless channel setting control unit 63, and demultiplexer unit 64.

The MAC control unit 60 controls the processing of the MAC layer by the MAC processing unit 22. The multiplexer unit 61 receives the RLC PDUs of the downlink data, which are output from the RLC processing unit 23, as the MAC SDUs. The multiplexer unit 61 multiplexes the control data and user data which are transmitted by different logic channels. The multiplexer unit 61 further segments or concatenates the data to generate packets of a predetermined length L2.

The retransmission control unit 62 adds headers, which contains control signals or sequence numbers, to packets which the multiplexer unit 61 generates, so as to generate MAC PDUs. The retransmission control unit 62 temporarily stores the MAC PDUs. Note that, sequence numbers of the headers may be omitted.

The wireless channel setting control unit 63 prepares a control signal for setting a wireless channel between the base station 2 and a mobile station 3. The MAC control signal, sometimes, is added to the MAC PDUs as the headers. As one example of setting a wireless channel, the wireless channel setting control unit 63 performs a random access routine. After the above processing is performed, the MAC PDUs are output from the MAC processing unit 22 to the transmission unit 20.

The retransmission control unit 62 receives the result of error judgment of the reception signal of the uplink data, from the reception unit 21. If the reception signal has no error, the retransmission control unit 62 outputs an acknowledge response (ACK) to the transmission unit 20. If the reception signal includes error, the retransmission control unit 62 outputs a negative acknowledge response (NACK) to the transmission unit 20.

The demultiplexer unit 64 decomposes the MAC PDUs of packets received by the reception unit 21 into the individual logic packets and allocates the data to respective services. The demultiplexer unit 64 concatenates the data, which is decomposed into the individual logic packets, to assemble the MAC SDUs. The demultiplexing unit 64 outputs the MAC SDUs to the RLC processing unit 23.

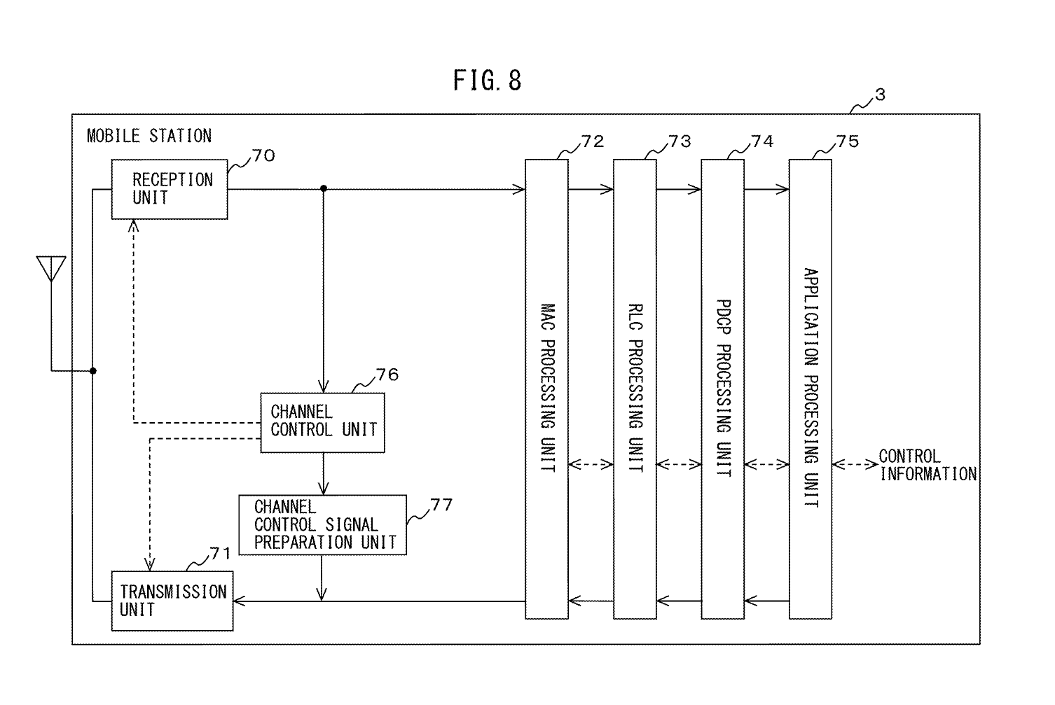

FIG. 8 is an explanatory view of a first example of the functional configuration of a mobile station 3. The mobile station 3 comprises a reception unit 70, transmission unit 71, MAC processing unit 72, RLC processing unit 73, PDCP processing unit 74, and application processing unit 75. The mobile station 3 comprises a channel control unit 76 and channel control signal preparation unit 77.

The reception unit 70 receives a downlink signal transmitted from the base station 2 through an antenna. The reception unit 70 amplifies the signal received and converts the amplified reception signal to an analog baseband signal. The reception unit 70 performs processing to convert the analog baseband signal to a digital baseband signal, processing to demodulate it, and processing to decode it.

The transmission unit 71 encodes and modulates an uplink signal to be transmitted to the base station 2 and maps the modulated signal on channels. The transmission unit 71 converts the signal of the different channels to an analog signal and converts the converted analog signal to a wireless frequency signal. The transmission unit 71 amplifies the wireless frequency signal and transmit the amplified signal to the base station 2 through the antenna.

The MAC processing unit 72 performs processing of the MAC layer of the uplink signal transmitted to the base station 2 and the downlink signal received from the base station 2. The RLC processing unit 73 performs processing of the RLC layer of the uplink signal transmitted to the base station 2 and the downlink signal received from the base station 2.

The PDCP processing unit 74 performs processing of the PDCP layer of the uplink data transmitted to the base station 2 and the downlink signal received from the base station 2. The application processing unit 75 performs predetermined data processing in accordance with the application program of the mobile station 3.

The channel control unit 76 receives the channel control signal transmitted from the base station 2. The channel control unit 76 controls the wireless resources and MCS used for the user data which the reception unit 70 and the transmission unit 71 receive and transmit, in accordance with the wireless resources and MCS which are designated by the channel control signal.

The channel control unit 76 receives the service class which is notified from the base station 2. The channel control unit 76 may control the transmission speed and transmission delay of the user data of the uplink from the mobile station 3 to the base station 2, in accordance with the service class which is notified from the base station 2.

For example, if the channel control unit 76 may request an uplink transmission by satisfying a request for the service quality designated by the service class and notifying the amount of uplink user data of the mobile station. Furthermore, it may request the wireless resources and MCS, which are used for the transmission, to the base station 2. For example, the channel control unit 76 outputs information for designating the service class, which is notified from the base station 2, to the channel control signal preparation unit 77. The channel control signal preparation unit 77 prepares a request signal of wireless resources, which signal contains information for designating the service class and the resources are used for transmission of user data of the uplink, and outputs it to the transmission unit 71. The transmission unit 71 transmits the request signal to the base station 2.

For example, when the base station 2 assigns wireless resources of the uplink, the channel control unit 76 may determine the resources to be assigned to the bearer from among the assigned resources, so as to satisfy the transmission delay and the condition of the transmission delay which are designated by the service class.

In the same way as the later explained third embodiment, the generation of small packets may also be detected at the mobile station 3. If the generation of small packets is detected, the channel control unit 76 may transmit information for identifying the class, attribute, or name of the application program, which causes the generation of the small packets, to the policy control device 7.

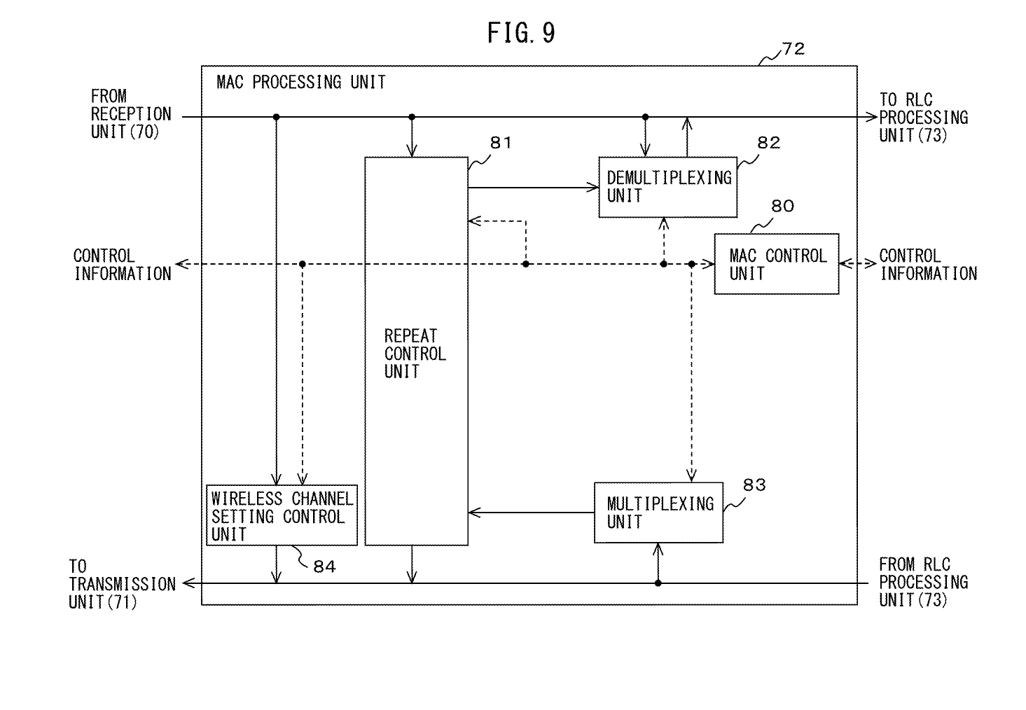

FIG. 9 is an explanatory view of a first example of the functional configuration of a MAC processing unit 72. The MAC processing unit 72 comprises a MAC control unit 80, retransmission control unit 81, demultiplexer unit 82, multiplexing unit 83, and wireless channel setting control unit 84.

The MAC control unit 80 controls the processing of the MAC layer by the MAC processing unit 72. The demultiplexing unit 82 decomposes the packets which are received at the reception unit 70, that is, the MAC PDUs, into individual logic packets and assigns the data to respective services. The demultiplexer unit 82 concatenates the data decomposed into the individual logic packets to assemble MAC SDUs. The demultiplexer unit 82 outputs the MAC SDUs to the RLC processing unit 73.

The multiplexing unit 83 receives the RLC PDUs of the uplink data output from the RLC processing unit 73, as MAC SDUs. The multiplexing unit 83 multiplexes the control data or user data which is transmitted by the different logic channels. The multiplexing unit 83 further segments or concatenates the data to generate packets of a predetermined length L3.

The retransmission control unit 81 adds headers, which contain control information or sequence numbers, to the packets which the multiplexing unit 83 generates, so as to generate MAC PDUs. The retransmission control unit 81 temporarily stores the MAC PDUs. The retransmission control unit 81 receives results of judgment of error of the reception signal of the downlink data from the reception unit 70. If the reception signal has no error, the retransmission control unit 81 outputs an acknowledge response (ACK) to the transmission unit 71. If the reception signal includes error, the retransmission control unit 81 outputs a negative acknowledge response (NACK) to the transmission unit 71. The wireless channel setting control unit 84 performs processing for establishing a wireless channel between the mobile station 3 and the base station 2. Note that, sequence numbers of the headers may be omitted.

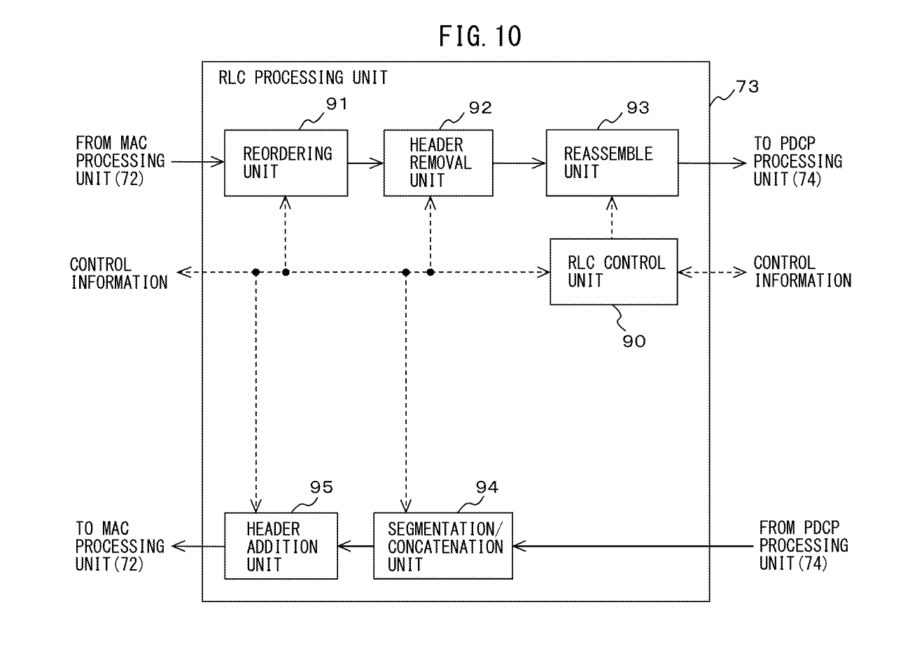

FIG. 10 is an explanatory view of a first example of the functional configuration of the RLC processing unit 73. The RLC processing unit 73 comprises an RLC control unit 90, reordering unit 91, header removal unit 92, reassemble unit 93, segmentation/concatenation unit 94, and header addition unit 95.

The RLC control unit 90 controls the processing of the RLC layer by the RLC processing unit 73. The reordering unit 91 receives the MAC SDUs of the downlink data output from the MAC processing unit 72, as RLC PDUs. The reordering unit 91 rearranges the order of the RLC PDUs and inputs them to the header removal unit 92. The header removal unit 92 removes the headers from the RLC PDUs. The reassemble unit 93 couples the packets, from which the headers have been removed, and assembles PDCP PDUs. The reassemble unit 93 outputs the PDCP PDUs to the PDCP processing unit 74.

The segmentation/concatenation unit 94 receives the PDCP PDUs of the uplink data output from the PDCP processing unit 74, as RLC SDUs. The segmentation/concatenation unit 94 segments or concatenates the received RLC SDUs to, thereby, generate packets of a predetermined length L4. The header addition unit 95 adds headers, which contain control signals or sequence numbers, to the packets which the segmentation/concatenation unit 94 generates, so as to generate RLC PDUs. The header addition unit 95 outputs the RLC PDUs to the MAC processing unit 72. Note that, sequence numbers of the headers may be omitted.

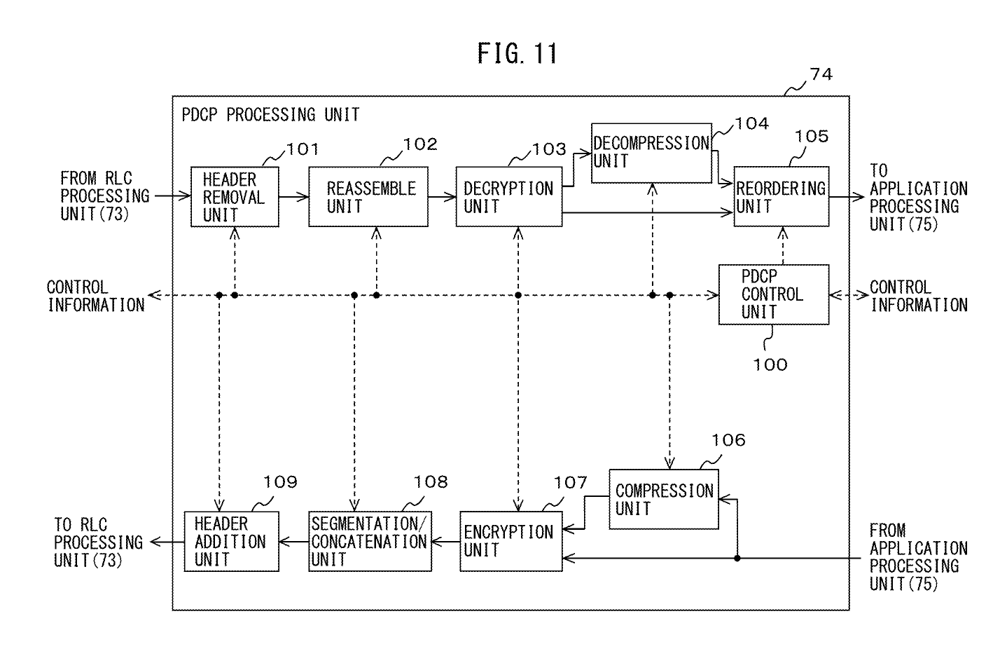

FIG. 11 is an explanatory view of a first example of the functional configuration of the PDCP processing unit 74. The PDCP processing unit 74 comprises a PDCP control unit 100, header removal unit 101, reassemble unit 102, decryption unit 103, decompression unit 104, and reordering unit 105. The PDCP processing unit 74 comprises a compression unit 106, encryption unit 107, segmentation/concatenation unit 108, and header addition unit 109.

The PDCP control unit 100 controls the processing of the PDCP layer by the PDCP processing unit 74. The header removal unit 101 receives the RLC SDUs of the downlink data output from the RLC processing unit 73, as PDCP PDUs. The header removal unit 101 removes the headers from the PDCP PDUs. The reassemble unit 102 concatenates the packets, from which the headers have been removed, and assembles the encrypted packets. The decryption unit 103 decrypts the encrypted packets to convert them to plain text packets. The decompression unit 104 returns the compressed headers contained in the plain text packets to the original headers. The reordering unit 105 rearranges the order of the plain text packets and outputs them, as PDCU SDUs, to the application processing unit 75.

The compression unit 106 compresses the header of the packets of the uplink data which are output from the application processing unit 75. The encryption unit 107 encrypts the packets of the uplink data. The segmentation/concatenation unit 108 segments or concatenates the packets, so as to generate packets of a predetermined length L5. The header addition unit 109 adds headers, which contain control signals or sequence numbers, to the packets which the segmentation/concatenation unit 108 generates, so as to generate PDCP PDUs. The header addition unit 109 outputs the PDCP PDUs to the RLC processing unit 73. Note that, sequence numbers of the headers may be omitted.

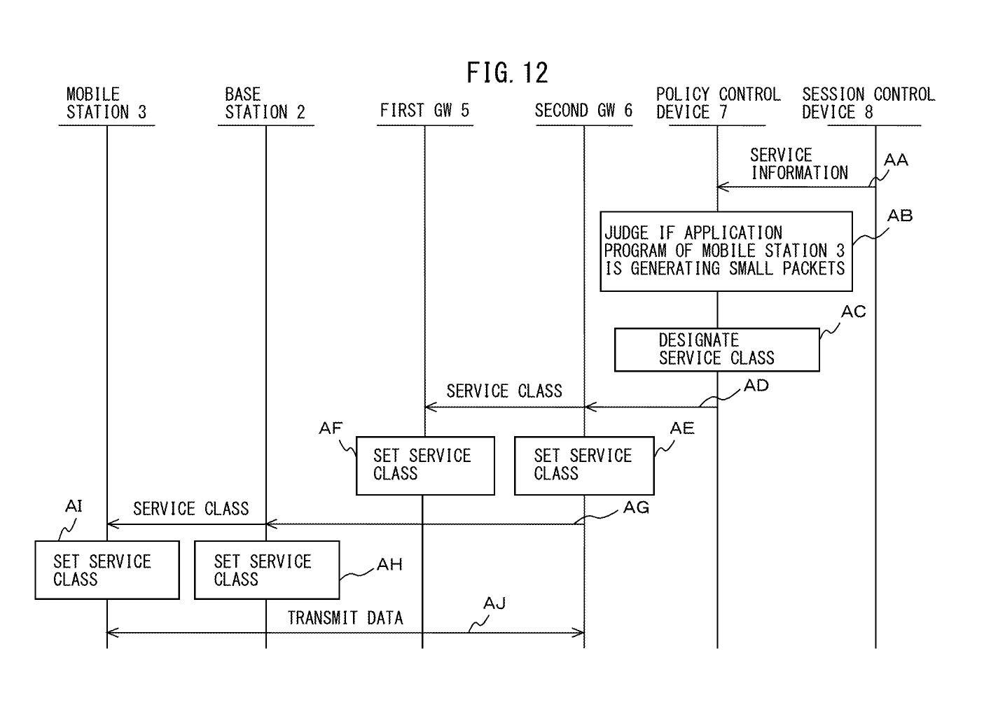

FIG. 12 is a sequence diagram for explaining a first example of operation of a communication system 1. At the operation AA, the policy control device 7 receives service information relating to the bearer of the mobile station 3 from the session control device 8. The operation AA corresponds to the operation of the communication unit 14.

At the operation AB, the policy control device 7 uses the identification information of the application program included in the service information, as the basis, to judge if the application program of the mobile station 3 is a program which causes the generation of small packets. The operation AB corresponds to the operation of the judgment unit 15.

When the application program of the mobile station 3 is a program which causes the generation of small packets, at the operation AC, the policy control device 7 designates the service class for transmission of small packets, as the service class to be applied to the bearer of the mobile station 3. The operation AC corresponds to the operation of the policy designation unit 16.

At the operation AD, the policy control device 7 notifies the service class, which is designated by the operation AC, to the first GW 5 and the second GW 6. The operation AD corresponds to the operation of the policy notification unit 17.

At the operation AE, the second GW 6 sets the service class which is applied to the bearer of the mobile station 3 to the service class which is designated at the operation AD. At the operation AF, the first GW 5 sets the service class, which is applied to the bearer of the mobile station 3, to the service class which is designated at the operation AD.

At the operation AG, the base station 2 receives the service class, which is designated by the policy control device 7, from the second GW 6. The operation AG, where the mobile station 3 receives the service class from the base station 2, corresponds to the operations of the channel control unit 25 and 76 and channel control signal preparation unit 26. At the operation AH, the base station 2 sets the service class, which is applied to the bearer of the mobile station 3, to the service class which is designated by the operation AD. The operation AH corresponds to the operation of the channel control unit 25. At the operation AI, the mobile station 3 sets the service class, which is applied to the bearer of the mobile station 3, to the service class which is designated by the operation AD. The operation AI corresponds to the operation of the channel control unit 76.

At the operation AJ, the mobile station 3 and second GW 5 transmit data between them through the bearer of the mobile station 3. The first GW 5 and second GW 6 control the transmission speed and transmission delay of the bearer of the mobile station 3, in accordance with service classes which are respectively set at the operations AF and AE. The channel control unit 25 of the base station 2 controls the transmission speed and transmission delay of the bearer of the mobile station 3, in accordance with the service class which is set at the operation AH. The channel control unit 76 of the mobile station 3 controls the transmission speed and transmission delay of the uplink bearer of the mobile station 3, in accordance with the service class which is set at the operation AI.

According to the present embodiment, the requests for service quality which are applied to bearers of small packets which cause congestion, are eased. As a result, by controlling the transmission speeds or transmission delays of bearers which includes small packets, it becomes possible to control the processing time for transmission, so the congestion at the network, at which bearers are set, due to small packets is decreased. By decreasing the congestion, the transmission speeds are improved and the required transmission speeds are satisfied. Further, the processing at the network or the processing at the devices, which form the network, can be decreased.

### 2. Second Embodiment

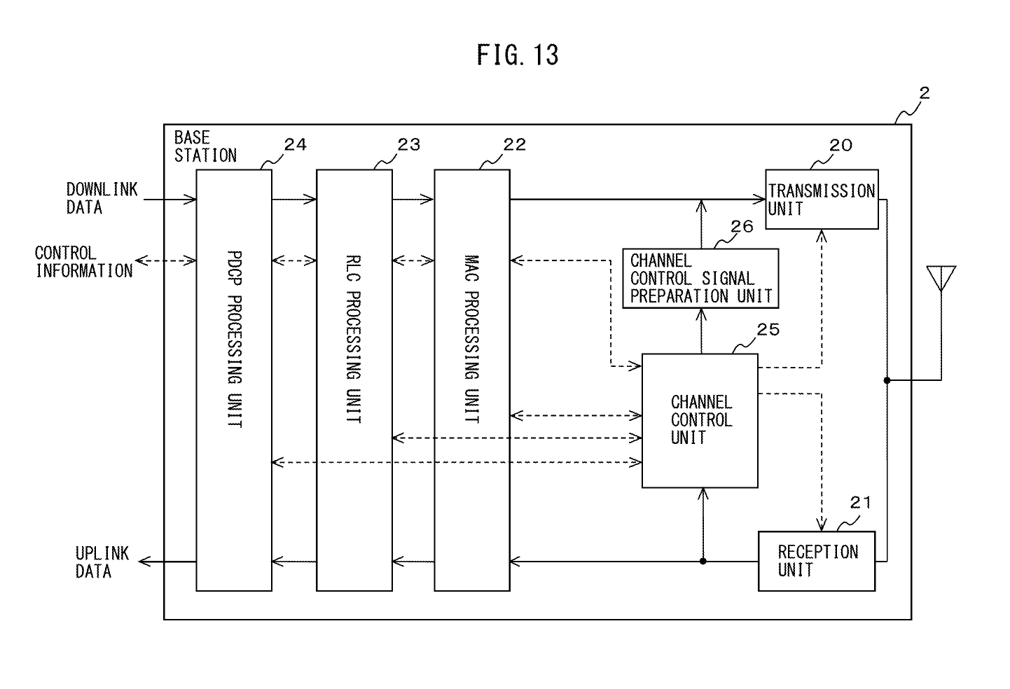

FIG. 13 is an explanatory view of a second example of the functional configuration of the base station 2. Component elements which are similar to the component elements illustrated in FIG. 4 are assigned reference notations the same as the reference notations used in FIG. 4. The MAC processing unit 22, RLC processing unit 23, and PDCP processing unit 24 detect small packets which are transmitted by a downlink bearer of a mobile station 3.

Note that, any one or two of the MAC processing unit 22, RLC processing unit 23, and PDCP processing unit 24 may detect the small packets, or all of the MAC processing unit 22, RLC processing unit 23, and PDCP processing unit 24 may detect the small packets.

If small packets are transmitted, the MAC processing unit 22, RLC processing unit 23, and PDCP processing unit 24 decide to change the service class which is applied to the bearer at which the small packets are detected and output a class control signal which requests change of the service class to the channel control unit 25. Receiving the class control signal, the channel control unit 25 transmits a change request signal. The change request signal requests change of the service class, which is applied to the bearer at which the small packets are detected, to the policy control device 7. The change request signal may, for example, include identification information for identifying the bearer at which the small packets are detected.

The policy control device 7 responds to the change request signal and transmits a change notification signal which instructs the service class to be applied to the bearer, at which the small packets are detected, to the first GW 5 and second GW 6. The change notification signal may include identification information for identifying the post-change service class and identification information for identifying the bearer at which the post-change service class is applied.

The request of the service quality of the post-change service class may be eased from the request of the service quality of the service class which had been applied before the small packets were detected. For example, a request relating to any of the required transmission speed, allowable transmission delay, quality of transmission, and allowable error rate of the post-change service class, may be eased compared with the request of the service class which had been applied before small packets were detected. The post-change service class may, for example, be the service class for transmission of small packets which was explained with reference to FIG. 3.

The second GW 6 transmits the change notification signal to the base station 2. If the channel control unit 25 receives a change notification signal, it changes the service class applied to the bearer of the mobile station 3 at which transmission of small packets has been detected, to the service class which is designated by the change notification signal. That is, the channel control unit 25 controls the transmission speed and transmission delay of the user data between the mobile station 3 and the base station 2, in accordance with the service class which is designated by the change notification signal. The channel control signal preparation unit 26 outputs the change notification signal to the transmission unit 20. The transmission unit 20 transmits the change notification signal to the mobile station 3. The channel control unit 76 of the mobile station 3 may also change the service class, which is applied to a bearer at which transmission of small packets has been detected, to the service class which is designated by the change notification signal.

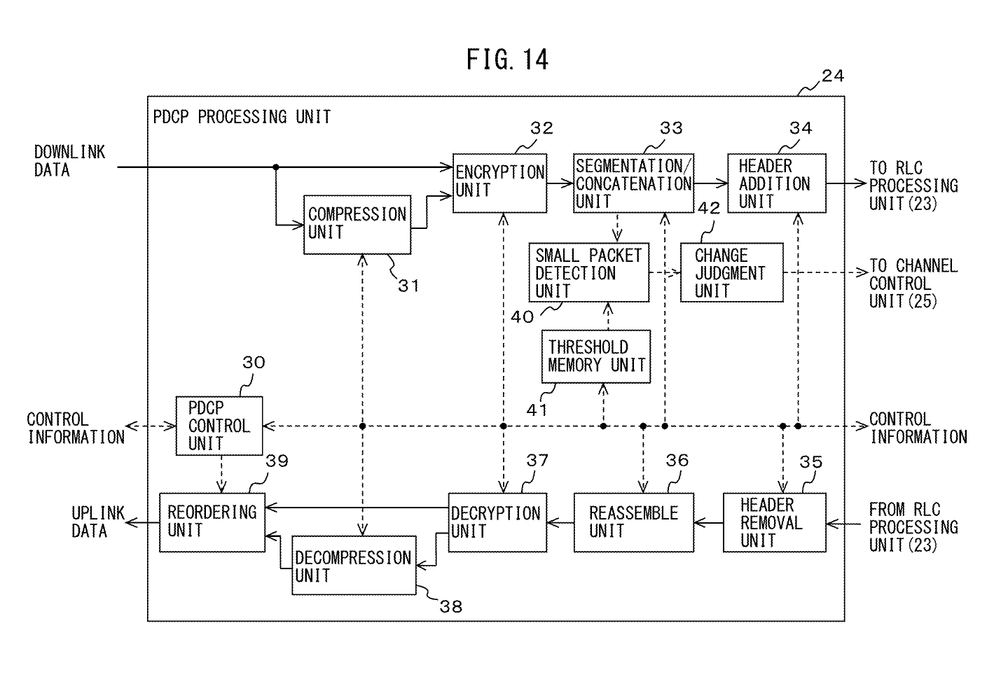

FIG. 14 is an explanatory view of a second example of the functional configuration of the PDCP processing unit 24 of a base station device. Component elements which are similar to the component elements illustrated in FIG. 5 are assigned reference notations the same as the reference notations which are used in FIG. 5. The PDCP processing unit 24 comprises a small packet detection unit 40, threshold value memory unit 41, and change judgment unit 42.

The small packet detection unit 40 detects the packet lengths of packets before they are segmented or concatenated at the segmentation/concatenation unit 33. The small packet detection unit 40 uses the detected packet lengths, as the basis, to judge, for each bearer, if the packets transmitted by the bearer are small packets.

For example, the small packet detection unit 40 compares the packet length of each of the packets transmitted by the bearer and a threshold value Lth0 stored in the threshold value memory unit 41. The small packet detection unit 40 may judge that small packets have been detected when there is even one packet with a packet length shorter than Lth0. The threshold value Lth0 may, for example, be the upper limit of the packet lengths of packets which are not processed to be segmented by the segmentation/concatenation unit 33. For example, the threshold value Lth0 may be the packet length L0 of packets L0 which are generated by the segmentation/concatenation unit 33.

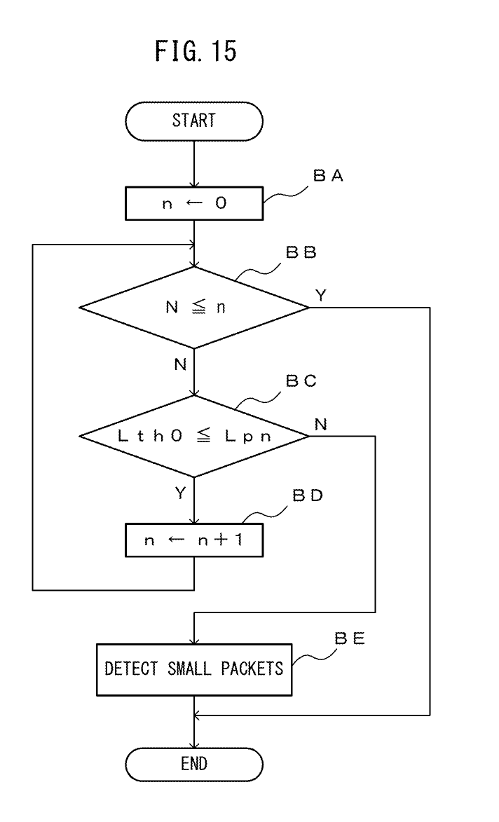

FIG. 15 is an explanatory view of a first example of an operation for detecting small packets. At the operation BA, the small packet detection unit 40 initializes the value of the variable “n”, for counting the times of judgment of the packet length, to “0”. At the operation BB, the small packet detection unit 40 judges if the value of the variable “n” is the upper limit N or more. If the value of the variable “n” is the upper limit N or more (operation BB: Y), the operation is ended. If the value of the variable “n” is not the upper limit N or more (operation BB: N), the operation proceeds to the operation BC.

At the operation BC, the small packet detection unit 40 judges if the detected packet length Lpn is the threshold value Lth0 or more. If the packet length Lpn is the threshold value Lth0 or more (operation BC: Y), the operation proceeds to the operation BD. If the packet length Lpn is not the threshold value Lth0 or more (operation BC: N), the operation proceeds to the operation BE.

At the operation BD, the small packet detection unit 40 increases the value of the variable “n” by “1”. After that, the operation returns to the operation BB. At the operation BE, the small packet detection unit 40 judges that small packets have been detected. After that, the operation is ended.

For example, the small packet detection unit 40 may also detect the frequency of generation of packets with packet lengths shorter than Lth0 and judge that small packets have been detected in accordance with that frequency of generation. For example, the small packet detection unit 40 may judge that small packets have been detected when the number of packets shorter than Lth0, which are included in a predetermined number of packets, is a threshold value or more. The small packet detection unit 40 may judge that small packets have been detected when the ratio of packets shorter than Lth0 in a predetermined number of packets, is a threshold value or more.

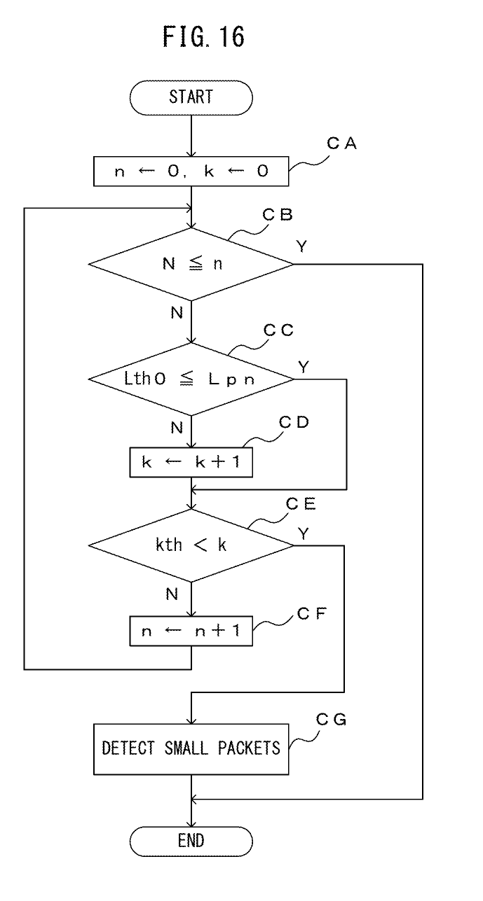

FIG. 16 is an explanatory view of a second example of an operation for detection of small packets. At the operation CA, the small packet detection unit 40 initializes to “0” the value of the variable “n” for counting the number of times of judgment of packet length and the value of the variable “k” for counting the number of times of detection of packets with packet lengths shorter than Lth0.

At the operation CB, the small packet detection unit 40 judges if the value of the variable “n” is the upper limit N or more. If the value of the variable “n” is the upper limit N or more (operation CB: Y), the operation is ended. If the value of the variable “n” is not the upper limit N or more (operation CB: N), the operation proceeds to the operation CC.

At the operation CC, the small packet detection unit 40 judges if the detected packet length Lpn is the threshold value Lth0 or more. If the packet length Lpn is the threshold value Lth0 or more (operation CC: Y), the operation proceeds to the operation CE. If the packet length Lpn is not the threshold value Lth0 or more (operation CC: N), the operation proceeds to the operation CD. At the operation CD, the small packet detection unit 40 increases the value of the variable “k” by “1”. After that, the operation proceeds to the operation CE.

At the operation CE, the small packet detection unit 40 judges if the value of the variable “k” is larger than a threshold value kth. If the value of the variable “k” is larger than the threshold value kth (operation CE: Y), the operation proceeds to the operation CG. If the value of the variable “k” is not larger than the threshold value kth (operation CE: N), the operation proceeds to the operation CF.

At the operation CF, the small packet detection unit 40 increases the value of the variable “n” by “1”. After that, the operation proceeds to the operation CB. At the operation CG, the small packet detection unit 40 judges that small packets have been detected. After that, the operation is ended.

Further, for example, the small packet detection unit 40 may judge that small packets have been detected when the number of packets shorter than Lth0, which packets are contained in the packets detected in a certain time period, is a threshold value or more. The small packet detection unit 40 may also judge that small packets have been detected when the ratio of packets shorter than Lth0 in the packets, which are detected in a certain time period, is a threshold value or more.

When small packets are transmitted, the small packet detection unit 40 notifies the generation of the small packets to the change judgment unit 42. When small packets are generated, the change judgment unit 42 decides to change the service class which is applied to the bearer at which the small packets are detected. The change judgment unit 42 outputs a class control signal, which requests change of the service class, to the channel control unit 25.

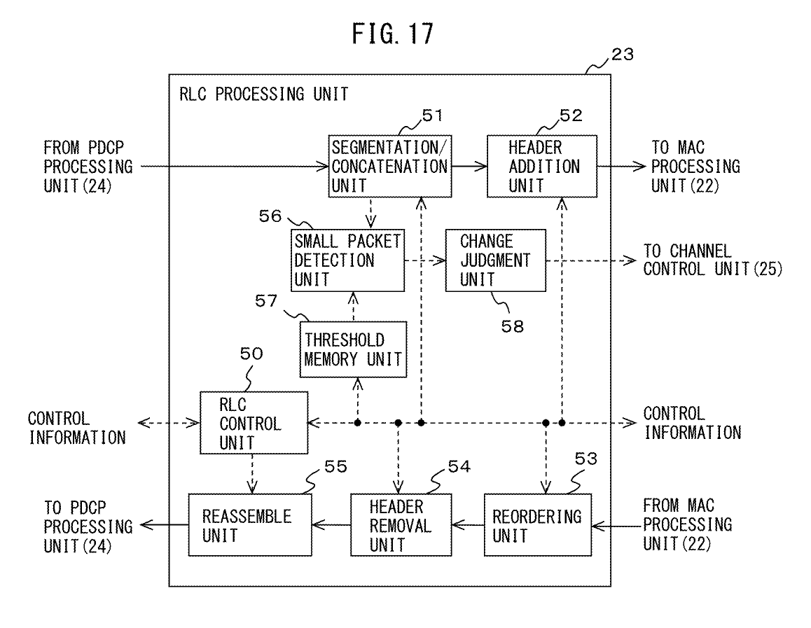

FIG. 17 is an explanatory view of a second example of the functional configuration of the RLC processing unit 23. Component elements which are similar to the component elements illustrated in FIG. 6 are assigned reference notations the same as the reference notations used in FIG. 6. The RLC processing unit 23 comprises a small packet detection unit 56, threshold value memory unit 57, and change judgment unit 58.

The small packet detection unit 56 detects the packet lengths of packets before they are segmented or concatenated by the segmentation/concatenation unit 51. The small packet detection unit 56 uses the detected packet lengths, as the basis, to judge, for each bearer, if the packets which are transmitted by the bearer are small packets.

For example, the small packet detection unit 56 compares the packet length of each of the packets which are transmitted by a bearer and a threshold value Lth1 which is stored in the threshold value memory unit 57. If the small packet detection unit 56 detects even one packet with a packet length which is shorter than Lth1, it may judge that small packets have been detected. For example, the small packet detection unit 56 may detect the frequency of generation of packets which have packet lengths shorter than Lth1 and judge if small packets have been detected in accordance with that frequency of generation. The threshold value Lth1, for example, may be the upper limit of the packet lengths of packets which are not processed to be segmented by the segmentation/concatenation unit 51. For example, the threshold value Lth1 may also be the packet length L1.

When small packets are transmitted, the small packet detection unit 56 notifies the generation of the small packets to the change judgment unit 58. When small packets are generated, the change judgment unit 58 decides to change the service class which is applied to the bearer at which the small packets are detected. The change judgment unit 58 outputs a class control signal, which requests change of the service class, to the channel control unit 25.

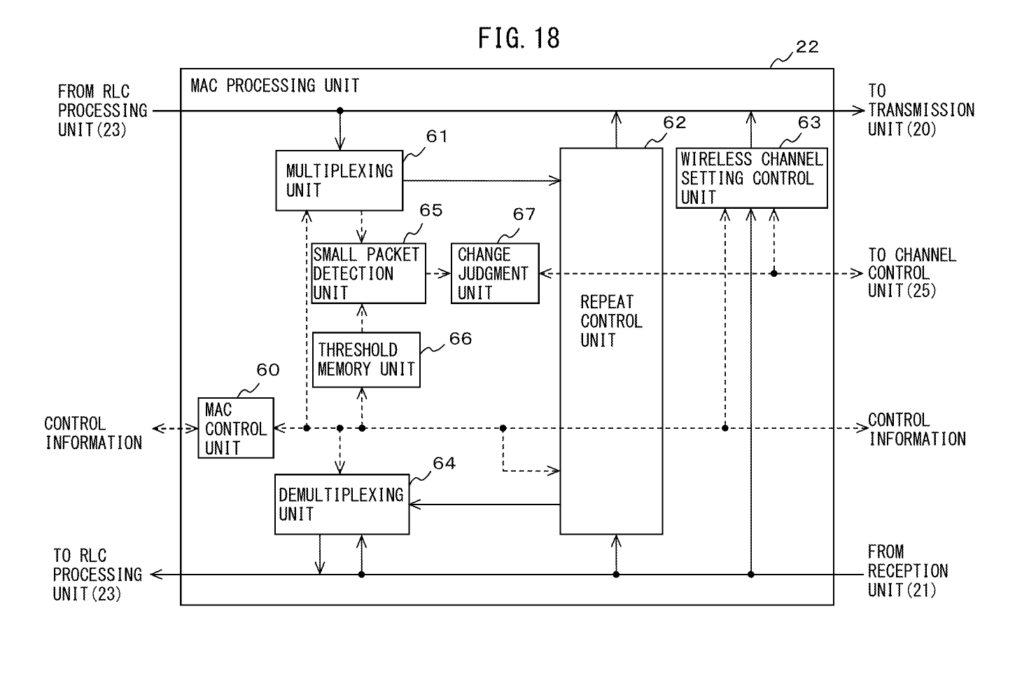

FIG. 18 is an explanatory view of a second example of the functional configuration of the MAC processing unit 22. Component elements which are similar to the component elements illustrated in FIG. 7 are assigned reference notations the same as the reference notations used in FIG. 7. The MAC processing unit 22 comprises a small packet detection unit 65, threshold value memory unit 66, and change judgment unit 67.

The small packet detection unit 65 detects the packet lengths of packets before they are multiplexed by the multiplexing unit 61. The small packet detection unit 65 uses the detected packet lengths, as the basis, to judge, for each bearer, whether the packets transmitted by the bearer are small packets.

For example, the small packet detection unit 65 compares the packet length of each of the packets which are transmitted by the bearer and a threshold value Lth2 which is stored in the threshold value memory unit 66. The small packet detection unit 65 may judge that small packets have been detected at the bearer when even one packet with a packet length, which is shorter than Lth2, is detected. For example, the small packet detection unit 65 may detect the frequency of generation of packets which have packet lengths smaller than Lth2 and judge that small packets have been detected, in accordance with that frequency of generation. The threshold value Lth2 may for example be the upper limit of the packet lengths of packets which are not processed to be segmented by the multiplexing unit 61. For example, the threshold value Lth2 may also be the packet length L2.

When small packets are transmitted, the small packet detection unit 65 notifies the generation of the small packets to the change judgment unit 67. When small packets are generated, the change judgment unit 67 decides to change the service class which is applied to the bearer at which the small packets are detected. The change judgment unit 67 outputs a class control signal, which requests change of the service class, to the channel control unit 25.

Note that, when the MAC processing unit 22 does not operate to detect small packets, the small packet detection unit 65, threshold value memory unit 66, and change judgment unit 67 may be omitted. When the RLC processing unit 23 does not operate to detect the small packets, the small packet detection unit 56, threshold value memory unit 57, and change judgment unit 58 may be omitted. When the PDCP processing unit 24 does not operate to detect small packets, the small packet detection unit 40, threshold value memory unit 41, and change judgment unit 42 may be omitted. As the threshold values Lth0, Lth1, and Lth2, which are compared with the detected packet lengths, the shortest value among the above predetermined values L0 to L2 may be used. A value unrelated to the predetermined values L0 to L2 may also be used.

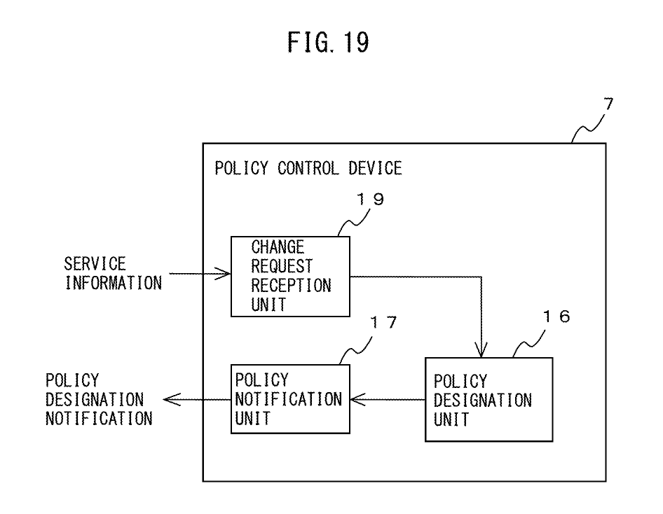

FIG. 19 is an explanatory view of a second example of the functional configuration of the policy control device 7. Component elements which are similar to the component elements illustrated in FIG. 2 are assigned reference notations the same as the reference notations used in FIG. 2. The policy control device 7 comprises a change request reception unit 19.

The change request reception unit 19 receives a change request signal which is transmitted from the base station 2. The change request reception unit 19 acquires the identification information, for identifying the bearer at which the small packets are detected, from the change request signal and outputs it to the policy designation unit 16.

The policy designation unit 16 designates, as the post-change service class, a service class of the request for service quality which is eased compared with the request for service quality of the service class which is currently applied to the bearer at which the small packets are detected. For example, the request relating to any of the required transmission speed, the allowable transmission delay, the quality of transmission, and the allowable error rate of the post-change service class may be eased from the request for the currently applied service class. The post-change service class, for example, may be the service class for transmission of small packets which was explained with reference to FIG. 3.

The policy designation unit 16 notifies the post-change service class to the policy notification unit 17. The policy notification unit 17 transmits the change notification signal, which designates the post-change service class, to the first GW 5 and second GW 6.

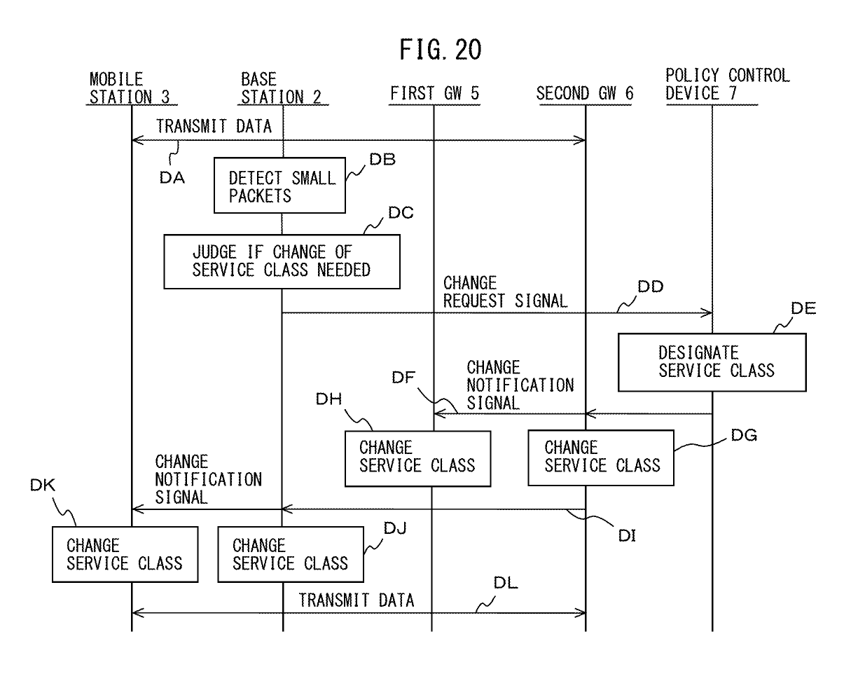

FIG. 20 is a sequence diagram for explaining a second example of operation of the communication system 1. At the operation DA, the mobile station 3 and the second GW 6 send data between them. At the operation DB, the base station 2 detects small packets which are transmitted between the mobile station 3 and second GW 6. The operation DB corresponds to the operations of the small packet detection units 40, 56, and 65.

When small packets have been transmitted, at the operation DC, the base station 2 decides to change the service class which is applied to the bearer of the mobile station 3 at which the small packets are detected. The operation DC corresponds to the operations of the change judgment units 42, 58, and 67. At the operation DD, the base station 2 transmits a change request signal to the policy control device 7. The operation DD corresponds to the operation of the channel control unit 25.

At the operation DE, the policy control device 7 designates the post-change service class which is to be applied to the bearer of the mobile station 3 at which the small packets are detected. The operation DE corresponds to the operation of the policy designation unit 16. At the operation DF, the policy control device 7 transmits the change notification signal to the first GW 5 and the second GW 6. The operation DF corresponds to the operation of the policy notification unit 17.

At the operation DG, the second GW 6 changes the service class, which is applied to the bearer of the mobile station at which the small packets are detected, from the current class to the class which is designated by the change notification signal. At the operation DH, the first GW 5 sets the service class, which is applied to the bearer of the mobile station 3 at which the small packets are detected, from the current class to the class which is designated by the change notification signal. At the operation DI, the base station 2 receives the change notification signal from the second GW 6. The mobile station 3 receives the change notification signal from the base station 2. The operation DI corresponds to the operations of the channel control unit 25 and 76 and channel control signal preparation unit 26.

At the operation DJ, the base station 2 sets the service class, which is applied to the bearer of the mobile station 3 at which the small packets are detected, from the current class to the class which is designated by the change notification signal. The operation DJ corresponds to the operation of the channel control unit 25. At the operation DK, the mobile station 3 sets the service class, which is applied to the bearer at which the small packets are detected, from the current class to the class which is designated by the change notification signal. The operation DJ corresponds to the operation of the channel control unit 76.

At the operation DL, data is transmitted between the mobile station 3 and the second GW 6 through the bearer of the mobile station 3. The first GW 5 and second GW 6 control the transmission speed and transmission delay of the bearer of the mobile station 3 at which the small packets are detected, in accordance with the post-change service class. The base station 2 controls the transmission speed and transmission delay of the bearer of the mobile station 3 at which the small packets are detected, in accordance with the post-change service class. The channel control unit 76 of the mobile station 3 controls the transmission speed and transmission delay of the bearer of the uplink at which the small packets are detected, in accordance with the post-change service class.

In the above embodiments, the MAC processing unit 22, RLC processing unit 23, and PDCP processing unit 24 detected the transmission of small packets at the downlink bearer. Instead of this or in addition to this, the base station 2 may also be modified so that the MAC processing unit 22, RLC processing unit 23, and PDCP processing unit 24 detect small packets at the uplink bearer. The same is true in the following other embodiments and their modifications.

Sometimes uplink and downlink data transmissions are performed paired. For example, sometimes uplink and downlink data transmissions are performed paired by the same application which is operating at the mobile station 3. The policy designation unit 16 may change, when changing the service class applied to the bearer used for one of the paired uplink and downlink data transmissions, the service class applied to the bearer which is used for the other of the paired uplink and downlink data transmissions. The policy designation unit 16 may change the paired classes so that the paired classes of bearers become the same classes as each other or may change them so that they become different classes from each other.

The policy designation unit 16 receives information, for identifying the application program which uses the bearer, from the mobile station 3 or the base station 2 and uses that information and the service class set for the bearer, as the basis, to identify the paired uplink and downlink bearers.

Instead of changing the service class, it is also possible to modify the second embodiment so as to change the request of the service quality which is applied to the bearer of the mobile station 3 at which the small packets are detected. For example, instead of changing the service class, it is also possible to change the second embodiment so as to change an attribute of the service class.

An “attribute” is an individual element of a request which determines the request for service quality of an individual service class. The attribute may, for example, be the required transmission speed, allowable transmission delay, priority, quality of transmission, or allowable error rate. The change judgment units 42, 58, and 67 decide to change the attribute of the service class which is applied to the bearer at which small packets are detected. The channel control unit 25 transmits a change request signal, which requests a change of an attribute of the service class applied to the bearer at which the small packets are detected, to the policy control device 7.

The policy designation unit 16 designates, as a post-change attribute, an attribute which is eased compared with an attribute of the service class currently applied to the bearer at which the small packets are detected. The post-change attribute may be eased from the attribute which had been applied before the small packets were detected. The policy notification unit 17 may transmit an identification information change notification which designates the post-change attribute. The first GW 5, second GW 6, base station 2, and mobile station 3 may control the transmission speed and transmission delay of the bearer of the mobile station 3 at which the small packets are detected, in accordance with the post-change attribute.

Similarly, in the later explained third embodiment and fourth embodiment as well, instead of changing the service class, it is possible to modify them so as to change the request of the service quality applied to the bearer of the mobile station 3 at which the small packets are detected.

According to the present embodiment, the requests for service quality which are applied to bearers of small packets which cause congestion, are eased. As a result, by controlling the transmission speeds or transmission delays of bearers which includes small packets, it becomes possible to control the processing time for transmission, so the congestion at the network, at which bearers are set, due to small packets is decreased. By decreasing the congestion, the transmission speeds are improved and the required transmission speeds are satisfied. Further, the processing at the network or the processing at the devices, which form the network, can be decreased.

### 3. Third Embodiment

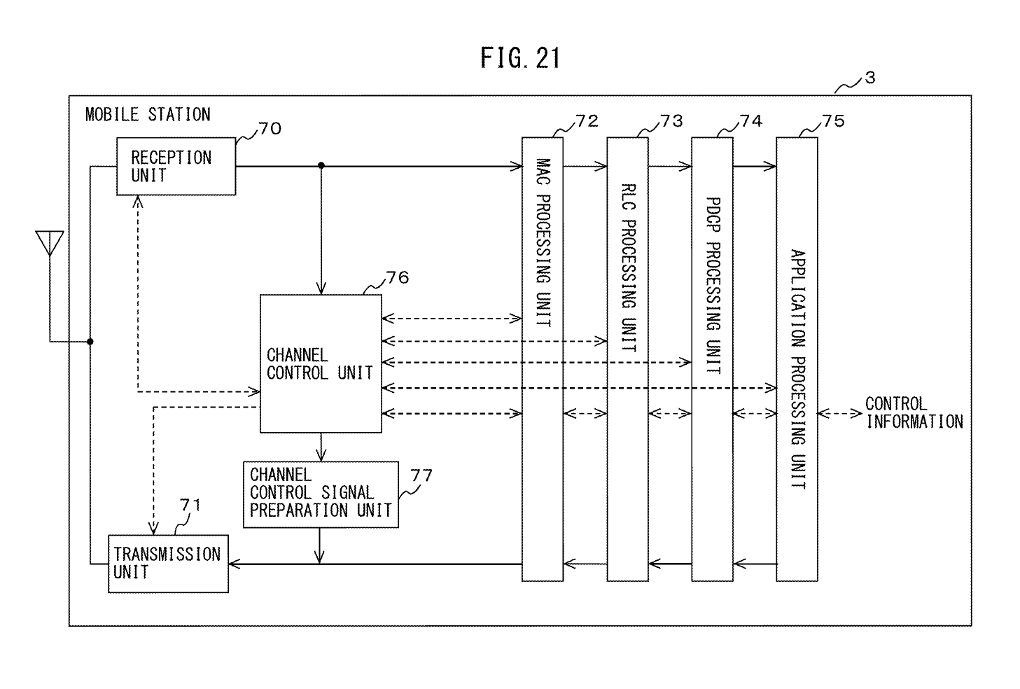

FIG. 21 is an explanatory view of a second example of the functional configuration of the mobile station 3. Component elements which are similar to the component elements illustrated in FIG. 8 are assigned reference notations the same as the reference notations used in FIG. 8. The MAC processing unit 72, RLC processing unit 73, and PDCP processing unit 74 detect small packets which are transmitted by the bearer of the uplink of the mobile station 3.

Any one or two of the MAC processing unit 72, RLC processing unit 73, and PDCP processing unit 74 may operate to detect small packets, or all of the MAC processing unit 72, RLC processing unit 73, and PDCP processing unit 74 may operate to detect small packets. The MAC processing unit 72, RLC processing unit 73, and PDCP processing unit 74 notify the generation of the small packets to the channel control unit 76.

When the MAC processing unit 72, RLC processing unit 73, and PDCP processing unit 74 notify the generation of small packets to the channel control unit 76, the channel control unit 76 requests to the channel control signal preparation unit 77 the preparation of a detection notification signal which notifies detection of small packets. The channel control signal preparation unit 77 prepares the detection notification signal and outputs it to the transmission unit 71. The transmission unit 71 transmits the detection notification signal to the base station 2.

The channel control unit 25 of the base station 2 receives the detection notification signal. When receiving the detection notification signal, the channel control unit 25 decides to change the service class applied to the bearer at which the small packets are detected. The channel control unit 25 transmits a change request signal, which requests change of the service class applied to the bearer at which the small packets are detected, to the policy control device 7. The rest of the operations are similar to the second embodiment.

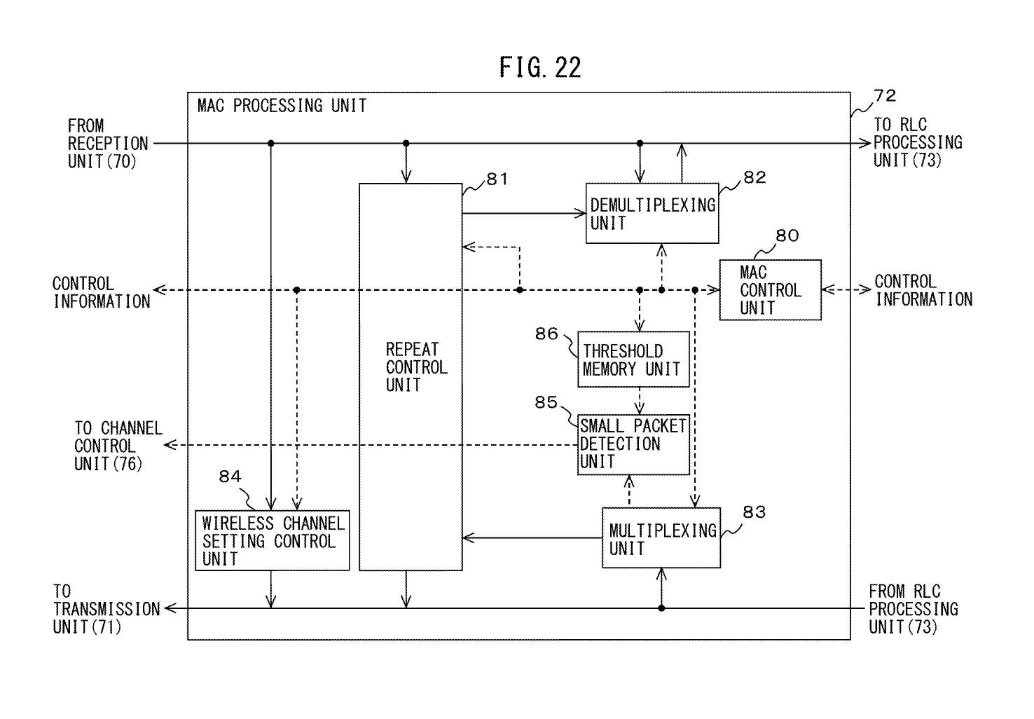

FIG. 22 is an explanatory view of a second example of the functional configuration of the MAC processing unit 72. Component elements which are similar to the component elements illustrated in FIG. 9 are assigned reference notations the same as the reference notations used in FIG. 9. The MAC processing unit 72 comprises a small packet detection unit 85 and threshold value memory unit 86.

The small packet detection unit 85 detects the packet lengths of the packets before they are multiplexed at the multiplexing unit 83. The small packet detection unit 85 uses the detected packet lengths, as the basis, to judge, for each bearer, whether the packets transmitted by the bearer are small packets.

For example, the small packet detection unit 85 compares the packet length of each of the packets transmitted by the bearer and a threshold value Lth3 stored in the threshold value memory unit 86. The small packet detection unit 85 may judge that small packets have been detected at the bearer when there is even one packet with a packet length which is shorter than Lth3. For example, the small packet detection unit 85 may detect the frequency of generation of packets with packet lengths shorter than Lth3 and judge that small packets have been detected in accordance with this frequency of generation.

The threshold value Lth3 may, for example, be the upper limit of the packet lengths of packets which are not processed to be segmented by the multiplexing unit 83. For example, the threshold value Lth3 may be the packet length L3. When small packets are transmitted, the small packet detection unit 85 notifies the generation of the small packets to the channel control unit 76.

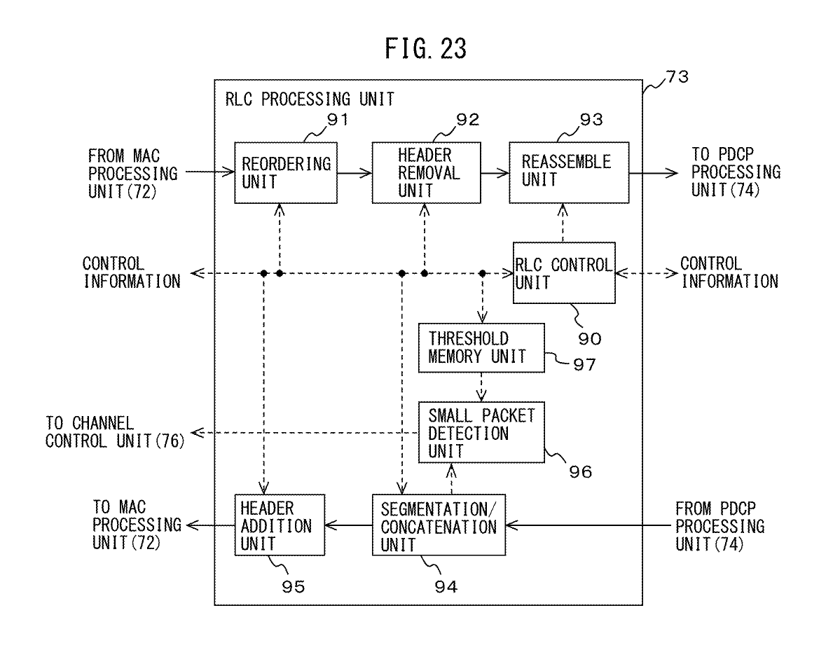

FIG. 23 is an explanatory view of a second example of the functional configuration of the RLC processing unit 73. Component elements which are similar to the component elements illustrated in FIG. 10 are assigned reference notations the same as the reference notations used in FIG. 1. The RLC processing unit 73 comprises a small packet detection unit 96 and threshold value memory unit 97.

The small packet detection unit 96 detects the packet lengths of packets before they are segmented or concatenated at the segmentation/concatenation unit 94. The small packet detection unit 96 uses the detected packet lengths, as the basis, to judge for each bearer if the packets transmitted by the bearer are small packets.

For example, the small packet detection unit 96 compares the packet length of each of the packets transmitted by a bearer with a threshold value Lth4 stored at the threshold value memory unit 97. The small packet detection unit 96 may judge that small packets have been detected at a bearer when even one packet with a packet length shorter than Lth4 is detected. For example, the small packet detection unit 96 may also detect the frequency of generation of packets with packet lengths shorter than Lth4 and judge that small packets have been detected in accordance with the frequency of generation.

The threshold value Lth4, for example, may be the upper limit of the packet lengths of packets which are not processed for segmentation by the segmentation/concatenation unit 94. For example, the threshold value Lth4 may be the packet length L4. When small packets are transmitted, the small packet detection unit 96 notifies the generation of the small packets to the channel control unit 76.

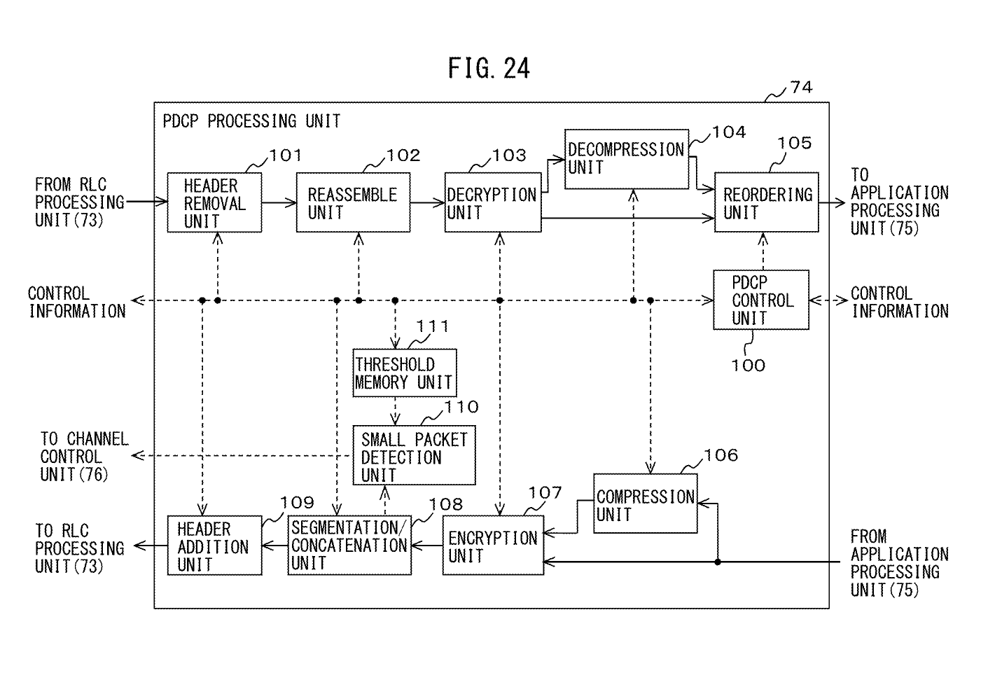

FIG. 24 is an explanatory view of a second example of the functional configuration of the PDCP processing unit 74. Component elements which are similar to the component elements illustrated in FIG. 1 are assigned reference notations the same as the reference notations used in FIG. 11. The PDCP processing unit 74 comprises a small packet detection unit 110 and threshold value memory unit 111.

The small packet detection unit 110 detects the packet lengths of packets before they are segmented or concatenated at the segmentation/concatenation unit 108. The small packet detection unit 110 uses the detected packet lengths, as the basis, to judge for each bearer if the packets transmitted by the bearer are small packets.

For example, the small packet detection unit 110 compares the packet length of each of the packets transmitted by the bearer with the threshold value Lth5 stored in the threshold value memory unit 111. The small packet detection unit 110 may judge that small packets have been detected at a bearer when there is even one packet with a packet length which is shorter than Lth5. For example, the small packet detection unit 110 may detect the frequency of generation of packets with packet lengths shorter than Lth5 and judge that small packets have been detected in accordance with the frequency of generation.

The threshold value Lth5, for example, may be the upper limit of the packet lengths of packets which are not processed for segmentation by the segmentation/concatenation unit 108. For example, the threshold value Lth5 may be the packet length L5. When small packets are transmitted, the small packet detection unit 110 notifies the generation of the small packets to the channel control unit 76.

When the MAC processing unit 72 does not operate to detect small packets, the small packet detection unit 85 and the threshold value memory unit 86 may be omitted. When the RLC processing unit 73 does not operate to detect small packets, the small packet detection unit 96 and the threshold value memory unit 97 may be omitted. When the PDCP processing unit 74 does not operate to detect small packets, the small packet detection unit 110 and threshold value memory unit 111 may be omitted. As the threshold values Lth3, Lth4 and Lth5 which are compared with the detected packet lengths, the shortest value among the above predetermined values L3 to L5 may be used. A value unrelated with the predetermined values L3 to L5 may also be used.

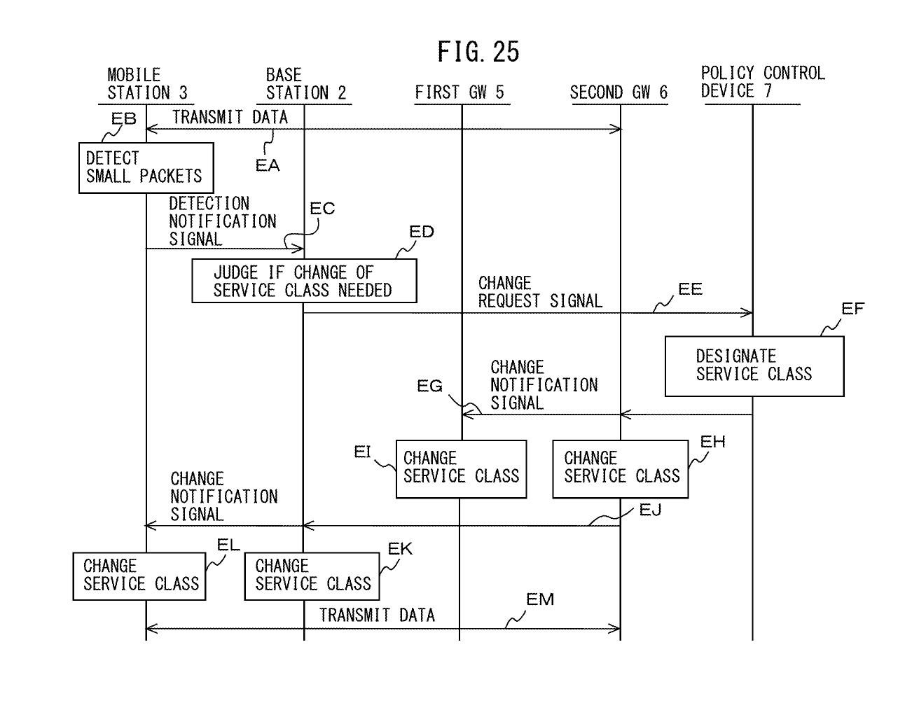

FIG. 25 is a sequence diagram for explaining a third example of the operation of the communication system 1. At the operation EA, the mobile station 3 and the second GW 6 transmit data between each other. At the operation EB, the mobile station 3 detects small packets which are transmitted by a bearer between the mobile station 3 and the second GW 6. The operation EB corresponds to the operations of the small packet detection units 85, 96, and 110.

At the operation EC, the mobile station 3 transmits a detection notification signal to the base station 2. The operation EC corresponds to the operations of the channel control signal preparation unit 77 and the transmission unit 71. At the operation ED, the base station 2 decides to change the service class applied to the bearer of the mobile station 3 at which the small packets are detected. The operation DC corresponds to the operation of the channel control unit 25. The operations EE to EM are similar to the operations of the operations DD to DL of FIG. 20.

According to the present embodiment, the requests for service quality which are applied to bearers of the small packets which cause congestion, are eased. As a result, by controlling the transmission speeds or transmission delays of bearers which includes small packets, it becomes possible to control the processing time for transmission, so the congestion at the network, at which bearers are set, due to small packets is decreased. By decreasing the congestion, the transmission speeds are improved and the required transmission speeds are satisfied. Further, the processing at the network or the processing at the devices, which form the network, can be decreased.

According to the present embodiment, the processing for detection of small packets generated in the bearers of the mobile stations 3 are dispersed among the mobile stations 3. For this reason, increase of load of the base station 2 for detecting the small packets can be avoided.

In the above embodiments, the MAC processing unit 72, RLC processing unit 73, and PDCP processing unit 74 detects the transmission of small packets at the uplink bearer. Instead of this or in addition to this, the base station 2 may be modified so that the MAC processing unit 72, RLC processing unit 73, and PDCP processing unit 74 detect small packets at the downlink bearer. The same is true in the following other embodiments and their modifications.

### 4. Fourth Embodiment

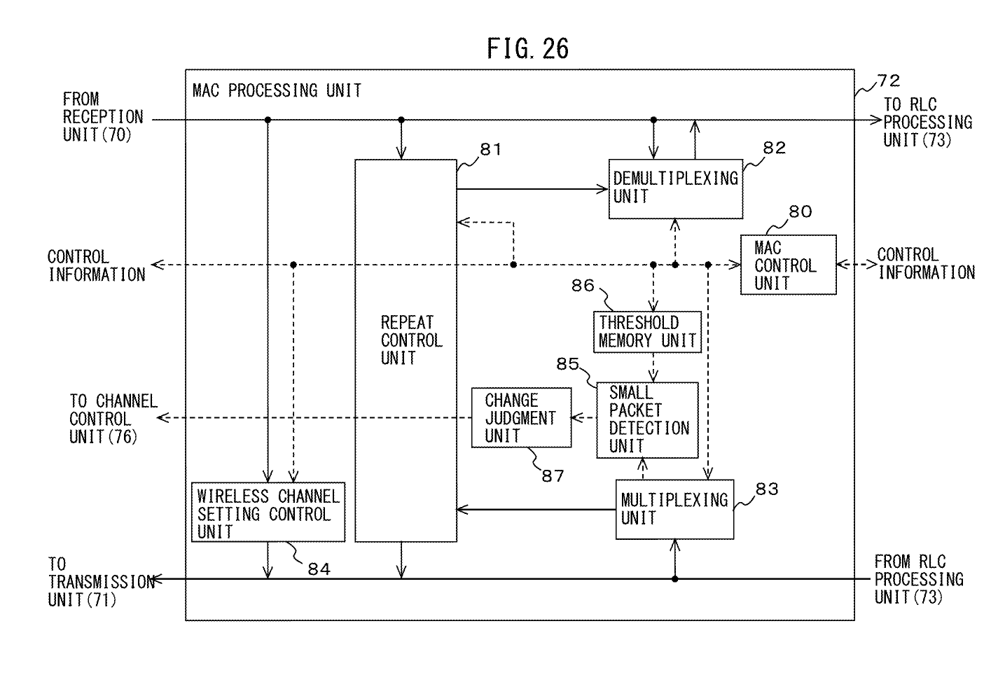

FIG. 26 is an explanatory view of a third example of the functional configuration of a MAC processing unit 72. Component elements which are similar to the component elements illustrated in FIG. 22 are assigned reference notations the same as the reference notations used in FIG. 22. The MAC processing unit 72 comprises a change judgment unit 87. When packets are transmitted, the small packet detection unit 85 notifies the generation of small packets to the change judgment unit 87. When small packets are generated, the change judgment unit 87 decides to change the service class applied to the bearer at which the small packets are detected. The change judgment unit 87 outputs a class control signal which requests change of the service class to the channel control unit 76.

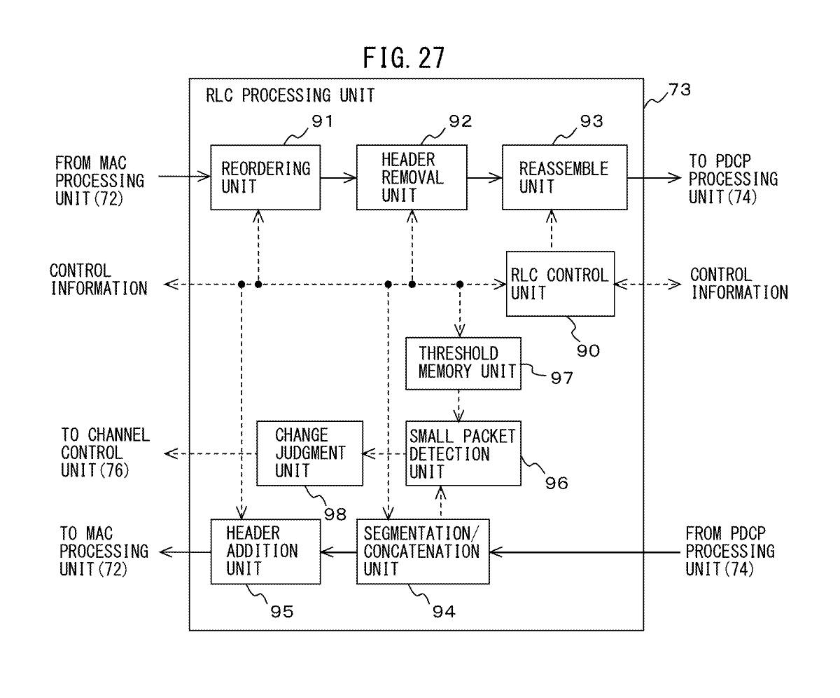

FIG. 27 is an explanatory view of a third example of the functional configuration of an RLC processing unit 73. Component elements which are similar to the component elements illustrated in FIG. 23 are assigned reference notations the same as the reference notations used in FIG. 23. The RLC processing unit 73 comprises a change judgment unit 98. When small packets are transmitted, the small packet detection unit 96 notifies the generation of the small packets to the change judgment unit 98. When small packets are generated, the change judgment unit 98 decides to change the service class applied to the bearer at which the small packets are detected. The change judgment unit 98 outputs a class control signal, which requests change of the service class, to the channel control unit 76.

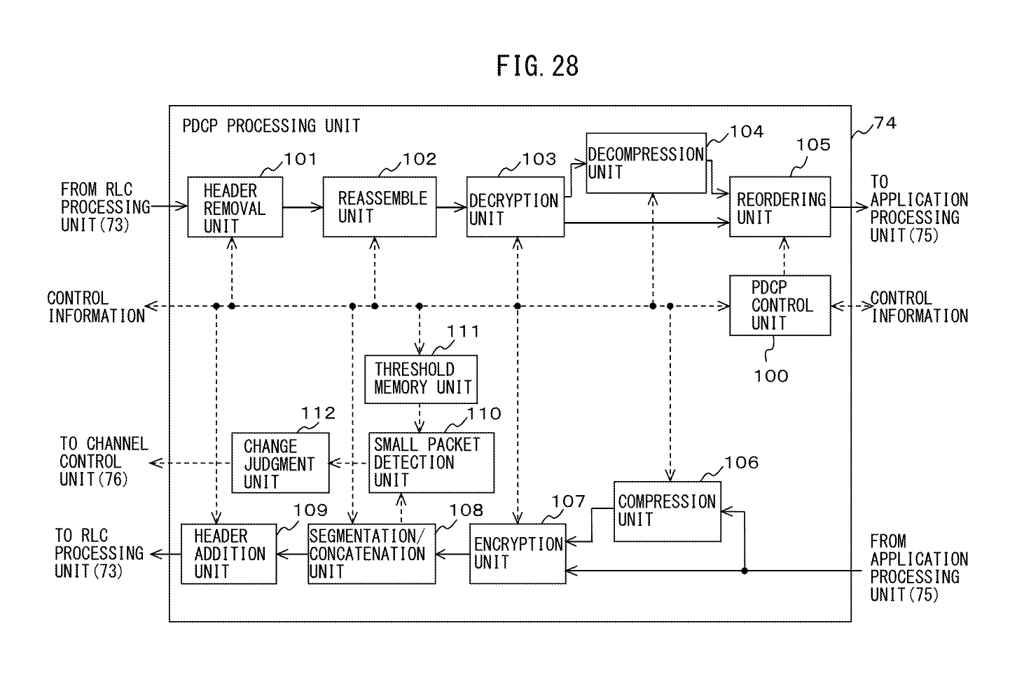

FIG. 28 is an explanatory view of a third example of the functional configuration of the PDCP processing unit 74. Component elements which are similar to the component elements illustrated in FIG. 24 are assigned reference notations the same as the reference notations used in FIG. 24. The PDCP processing unit 74 comprises a change judgment unit 112. When transmission of small packets occurs, the small packet detection unit 110 notifies the generation of small packets to the change judgment unit 112. When small packets are generated, the change judgment unit 112 decides to change the service class applied to the bearer at which the small packets are detected. The change judgment unit 112 outputs a class control signal, which requests a change of the service class, to the channel control unit 76.

Any one or two of the MAC processing unit 72, RLC processing unit 73, and PDCP processing unit 74 may operate to detect small packets, or all of the MAC processing unit 72, RLC processing unit 73, and PDCP processing unit 74 may operate to detect small packets. When the MAC processing unit 72 does not operate to detect small packets, the small packet detection unit 85, threshold value storage unit 86, and change judgment unit 87 may be omitted. When the RLC processing unit 73 does not operate to detect small packets, the small packet detection unit 96, threshold value memory unit 97, and change judgment unit 98 may be omitted. When the PDCP processing unit 74 does not operate to detect small packets, the small packet detection unit 110, threshold value memory unit 111, and change judgment unit 112 may be omitted.

Refer to FIG. 21. The channel control unit 76 which receives the class control signal requests the channel control signal preparation unit 77 to prepare a change request signal which requests a change of the service class applied to the bearer at which small packets are detected. The channel control signal preparation unit 77 prepares a change request signal and outputs it to the transmission unit 71. The transmission unit 71 transmits the change request signal to the base station 2.

The channel control unit 25 of the base station 2 receives a change request signal. The channel control unit 25 transmits the change request signal to the policy control device 7. The rest of the operations are similar to the second embodiment.

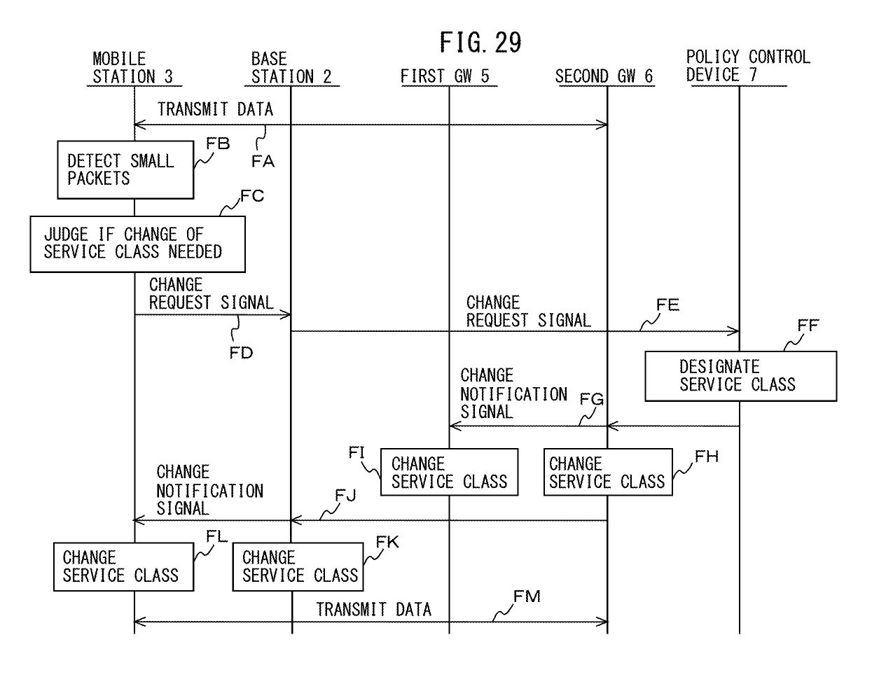

FIG. 29 is a sequence diagram for explaining a fourth example of the operation of the communication system 1. At the operation FA, the mobile station 3 and the second GW 6 send data between them. At the operation FB, the mobile station 3 detects small packets which are transmitted between the mobile station 3 and the second GW 6. The operation FB corresponds to the operations of the small packet detection units 85, 96, and 110.

When small packets are transmitted, at the operation FC, the mobile station 3 decides to change the service class applied to the bearer of the mobile station 3 at which the small packets are detected. The operation FC corresponds to the operations of the change judgment units 87, 98, and 112. At the operation FD, the mobile station 3 transmits the change request signal to the base station 2. The operation FD corresponds to the operations of the channel control signal preparation unit 77 and the transmission unit 71.

At the operation FE, the base station transmits a change request signal to the policy control device 7. The operation FE corresponds to operation of the channel control unit 25. The operations FF to FM are similar to the operations of the operations DE to DL of FIG. 20.

According to the present embodiment, the requests for service quality which are applied to bearers of small packets which cause congestion, are eased. As a result, by controlling the transmission speeds or transmission delays of bearers which includes small packets, it becomes possible to control the processing time for transmission, so the congestion at the network, at which bearers are set, due to small packets is decreased. By decreasing the congestion, the transmission speeds are improved and the required transmission speeds are satisfied. Further, the processing at the network or the processing at the devices, which form the network, can be decreased.

According to the present embodiment, the processing for detecting small packets, which are generated at the bearers of mobile stations 3, is dispersed among the mobile stations 3. For this reason, the increase of the load of the base station 2 for detecting small packets can be avoided.

In the above explanation, the views of the functional configurations of FIG. 2, FIG. 4 to FIG. 11, FIG. 13, FIG. 14, FIG. 17 to FIG. 19, FIG. 21 to FIG. 24, and FIG. 26 to FIG. 28 mainly illustrate the configurations relating to the functions which are explained herein. The base station 2, mobile station 3, and policy control device 7 may also include other component elements other than the illustrated component elements. The series of operations which are explained with reference to FIG. 12, FIG. 15, FIG. 16, FIG. 20, and FIG. 25 and FIG. 29 may be interpreted as methods which include pluralities of routines. In this case, “operation” may be read as “step”.

### 5. Hardware Configuration

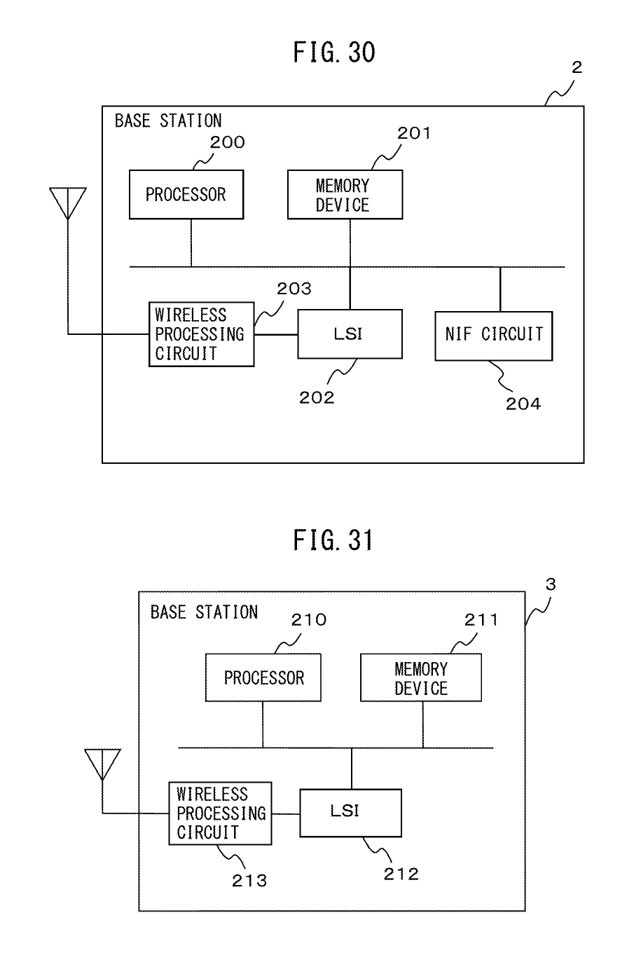

FIG. 30 is a view of the hardware configuration of one example of the base station 2. The base station device 2 comprises a CPU (Central Processing Unit) or other processor 200, memory device 201, LSI (Large Scale Integrated Circuit) 202, wireless processing circuit 203, and network interface circuit 204. In the following explanation and attached drawings, a network interface will sometimes be abbreviated as “NIF”.

The memory device 201 may include a device for storing a computer program or data such as a nonvolatile memory, read only memory (ROM) or random access memory (RAM), hard disk drive device, etc. The processor 200 performs user management processing other than the following processing which the LSI 202 performs or control of the operation of the base station 2 in accordance with a computer program which is stored in the memory device 201.

The LSI 202 performs encoding and modulation and demodulation and decoding of a signal which is sent and received with the mobile station 3, communication protocol processing, and processing of the baseband signal relating to scheduling. The LSI 202 may include an FPGA (Field-Programming Gate Array), ASIC (Application Specific Integrated Circuit), DSP (Digital Signal Processor), etc.

The wireless processing circuit 203 may include a digital-analog conversion circuit or analog-digital conversion circuit, a frequency conversion circuit, amplification circuit, filter circuit, etc. The NIF circuit 204 comprises electronic circuits for using the physical layer and data link layer to communicate with the first GW 5, second GW 6, policy control device 7, etc. through the cable network.

The above operations of the transmission unit 20 and the reception unit 21 of the base station 2 are for example realized by cooperation of the LSI 202 and the wireless processing circuit 203. The above operations of the MAC processing unit 22, RLC processing unit 23, and PDCP processing unit 24 of the base station 2 are for example realized by the LSI 202. The above operations of the channel control unit 25 and line control signal preparation unit 26 of the base station 2 are for example realized by the processor 200.

FIG. 31 is a view of the hardware configuration of one example of the mobile station 3. The mobile station 3 comprises a processor 210, memory device 211, LSI 212, and wireless processing circuit 213. The memory device 211 may include a device for storing a computer program or data such as a nonvolatile memory, read only memory or random access memory, etc.

The processor 210 controls operation of the mobile station 3 other than the processing which the LSI 212 performs and runs an application program which processes the user data in accordance with a computer program which is stored in a memory device 211.

The LSI 212 performs encoding and modulation and demodulation and decoding of a signal which is sent and received with the base station 2, communication protocol processing, and processing of the baseband signal relating to scheduling. The LSI 212 may include an FPGA, ASIC, DSP, etc.

The above operations of the reception unit 70 and the transmission unit 71 are realized by cooperation of the LSI 212 and the wireless processing circuit 213. The above operations of the MAC processing unit 72, the RLC processing unit 73, and the PDCP processing unit 74 are, for example, realized by the LSI 212. The above operations of the application processing unit 75, channel control unit 76, and channel control signal preparation unit 77 are, for example, realized by the processor 210.

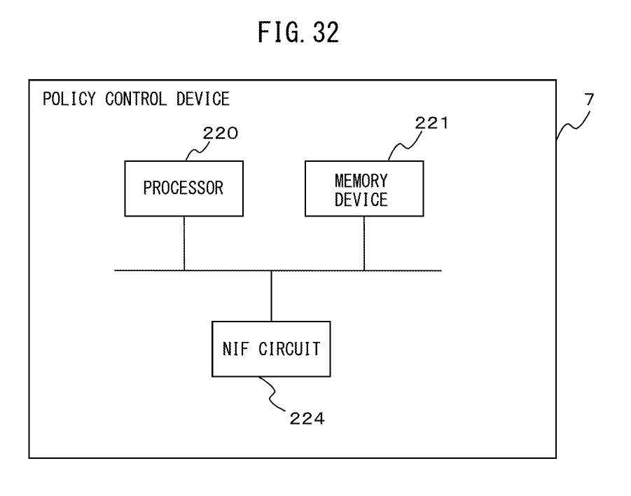

FIG. 32 is a view of the hardware configuration of one example of the policy control device 7. The policy control device 7 comprises a processor 220, memory device 221, and NIF circuit 224. The memory device 221 may be a nonvolatile memory, read only memory or random access memory, hard disk drive device, etc. for storing a computer program or data.

The processor 220 performs processing for policy control for transfer of data of a bearer between the second GW 6 and mobile station 3 in accordance with a computer program which is stored in the memory device 221. The NIF circuit 224 comprises an electronic circuit for communication with the first GW 5, second GW 6, base station 2, etc. using the physical layer and data link layer through a cable network.

The above operations of the communication unit 14 and change request reception unit 19 of the policy control device 7 are realized by the NIF circuit 224. The processings of the judgment unit 15 and policy designation unit 16 are realized by the processor 220. The above processing of the policy notification unit 17 is realized by cooperation of the processor 220 and the NIF circuit 224.

Note that the hardware configurations which are illustrated in FIG. 30 to FIG. 32 are illustrations for explaining the embodiments. So long as able to perform the above operations, the base station, mobile station, and policy control device which are described herein may employ any other hardware configuration.

All examples and conditional language recited hereinafter are intended for pedagogical purposes to aid the reader in understanding the principles of the invention and the concepts contributed by the inventors to furthering the art and are to be construed as being without limitation to such specifically recited examples and conditions. Nor does the organization of such examples in the specification relate to an illustration of the superiority and inferiority of the invention. Although the embodiments of the present inventions have been described in detail, it should be understood that the various changes, substitutions, and alterations could be made hereto without departing from the spirit and scope of the invention.

### REFERENCE SIGNS LIST

1. communication system
2. base station device
3. mobile station device
4. first network
5. first GW
6. second GW
7. policy control device
8. session control device
9. second network

What is claimed is:

1. A base station device comprising:
a detector which obtains the results of detection of the packet lengths of packets which are transmitted by data communication of a mobile station device; and
a service-quality request control circuit which controls a request for service quality for data communication according to said results of detection.

2. The base station device according to claim 1, wherein said service-quality request control circuit controls a service class, which indicates a request for service quality for said data communication, or an attribute of said service class.

3. The base station device according to claim 2, wherein the attribute of said service class is a required communication speed or allowable transmission delay of said data communication.

4. The base station device according to claim 1, wherein said service-quality request control circuit comprises:
a change request circuit which requests a change of said request for service quality to a service-quality control device which designates a service quality for said data communication;
a notification receiver which receives a notification of change designating a service quality request which is changed by said service-quality control device; and
a communication control circuit which controls data communication between said mobile station device and said base station device in accordance with a request for service quality which is designated by said notification of change.

5. The base station device according to claim 4, wherein,
said base station device is concatenated to a first network,
said first network transmits packets of said data communication between said base station device and second network, and
said service-quality control device responds to the request by said change request circuit and changes the request for service quality for said data communication in said first network.

6. The base station device according to claim 1, wherein said detector receives, from said mobile station device, said results of detection which are detected by said mobile station device.

7. The base station device according to claim 1, wherein
said detector detects a frequency by which the packet lengths of packets become a predetermined packet length or less, which packets are transmitted by data communication of said mobile station device, and
said service-quality request control circuit controls the request for service quality for said data communication in accordance with said frequency.

8. A mobile station device comprising:
a detector which detects packet lengths of packets which are transmitted by data communication of the mobile station device; and
a service-quality request control circuit which controls a request for service quality for the data communication according to the results of detection by said detector.

9. The mobile station device according to claim 8, wherein said service-quality request control circuit controls a service class which indicates a request for service quality for said data communication, or an attribute of said service class.

10. The mobile station device according to claim 9, wherein the attribute of said service class is a required communication speed or allowable transmission delay of said data communication.

11. The mobile station device according to claim 8, wherein,
said service-quality request control circuit comprises a control signal transmitter which transmits a control signal, by which a change of said request for service quality is requested to the base station device, to a service-quality control device which designates a request for service quality for said data communication.

12. The mobile station device according to claim 11, wherein,
said base station device is concatenated to a first network,
said first network transmits packets of said data communication between said base station device and second network, and
said service-quality control device responds to the request by said base station device and changes the request for service quality of said data communication in said first network.

13. The mobile station device according to claim 11, wherein, said service-quality request control circuit comprises:
a notification receiver which receives, from said base station device, a notification of change which designates a request of service quality changed by said service-quality control device; and
a communication control circuit which controls data communication between said mobile station device and said base station device in accordance with a request of service quality which is designated by said notification of change.

14. The mobile station device according to claim 8, wherein,
said detector detects a frequency by which packet lengths of packets become a predetermined packet length or less, which packets are transmitted by data communication of said mobile station device, and
said service-quality request control circuit controls said request for service quality for said data communication in accordance with that frequency.

15. A communication system comprising:
a detector which obtains the results of detection of the packet lengths of packets which are transmitted by data communication of a mobile station device; and
a service-quality request control circuit which controls a request for service quality for data communication according to said results of detection.

16. A service-quality control device comprising:
a judgment circuit which judges if an application program, by which a mobile station device is performing processing for data communication, is generating packets which have packet lengths of a threshold value or less; and
a service-quality request designation circuit which designates a request for service quality, which differs in accordance with the results of judgment of said judgment circuit, as a request for service quality for data communication by said application program.

17. A method of communication comprising:
detecting packet lengths of packets which are transmitted by data communication of a mobile station device, by a processor; and
controlling a request for service quality for said data communication according to said results of detection of said detecting, by the processor.

18. A method of communication comprising:
judging if an application program, by which a mobile station device is performing processing for data communication, is generating packets which have packet lengths of a threshold value or less, by a processor; and
designating a request for service quality, which differs in accordance with the results of judgment of said judging, as a request for service quality for data communication by said application program, by the processor.
